(19) United States
(12) Patent Application Publication
(10) Pub. No.: US 2025/0335717 A1
(43) Pub. Date: Oct. 30, 2025

(54) DETERMINING AND REVEALING INTERPRETATIONS OF ARTIFICIAL INTELLIGENCE MODELS

(71) Applicant: MicroStrategy Incorporated, Vienna, VA (US)

(72) Inventors: Jingbin Zhang, Hangzhou (CN); Tingting Jin, Vienna, VA (US); Abdul Rahman, Warsaw (PL); Hanijanto Soewandi, Potomac, MD (US); Ananya Ojha, Dunn Loring, VA (US); Jaime Alberto Perez, Brambleton, VA (US)

(21) Appl. No.: 19/191,902

(22) Filed: Apr. 28, 2025

Related U.S. Application Data
(60) Provisional application No. 63/639,959, filed on Apr. 29, 2024.

(51) Int. Cl. G06F 40/35; G06F 16/248; G06F 40/289; G06F 40/40

(52) U.S. Cl. CPC G06F 40/35; G06F 16/248; G06F 40/289; G06F 40/40

(57) ABSTRACT

Methods, systems, and apparatus, including computer-readable media, for determining and revealing interpretations of artificial intelligence models. In some implementations, a system receives a prompt from a user. The system obtains code or instructions generated by a artificial intelligence or machine learning (AI/ML) model, where the code or instructions specify criteria to retrieve data from a data source to respond to the prompt. The system generates a set of results from the data source based on the generated code or instructions, and obtains a response to the prompt that an AI/ML model generates using at least a portion of the set of results. The system also generates an interpretation statement that indicates how the prompt was interpreted by the one or more AI/ML models. The system provides output that includes (i) the response to the prompt and (i) the generated interpretation statement.

### CROSS-REFERENCE TO RELATED APPLICATIONS

This application claims the benefit of priority to U.S. Provisional Patent Application No. 63/639,959, filed on Apr. 29, 2024, and the entire contents of the application are hereby incorporated herein by reference.

### BACKGROUND

The present specification relates to techniques for determining and revealing interpretations made by models for artificial intelligence and machine learning.

Artificial intelligence (AI) and machine learning (ML) techniques have improved significantly and continue to gain new capabilities. For example, neural network models, such as large language models, have shown the capability to process and to generate many types of natural language text. For example, chatbots that leverage large language models can respond to user prompts (e.g., user inputs such as questions) in text-based messaging sessions or conversations with users.

### SUMMARY

In some implementations, a computer system facilitates the use of artificial intelligence or machine learning (AI/ML) tools and can assist users by showing the interpretations used by AI/ML models. For example, the system can enhance AI/ML chatbots by providing information specifying the interpretations used by the chatbot in generating a response. This provides users context and background information that helps them better understand how their questions are perceived and which data objects were used in generating responses of chatbots. In addition, providing the chatbot's interpretation provides additional transparency about the data sources and data processing underlying the chatbot's response. When the chatbot's interpretation matches what the user expects, the user can have greater confidence in the content of the response. When the chatbot's interpretation is different from what the user expects, the user can more easily detect the difference and instruct the chatbot to make changes and try again.

One way that the system and provide an interpretation is by clearly articulating or restating the user's prompt to indicate how the AI/ML model has interpreted the user's question. In particular, the restatement can specify the types of data used and the relationships between them, and can indicate the logic and criteria of the user's original query. For example, the restatement can show a complete set of criteria for selecting or calculating the results the user requested. This restatement aims to eliminate ambiguities and present the query in its most straightforward form. As an example, a user may enter a prompt such as “Show the top 5 performing employees in terms of sales,” and this can be interpreted as: “Top five employees ranked by sales performance, sorted in descending order.” This approach ensures users understand which metrics are chosen to answer the prompt and shows how the prompt is processed. For example, the interpretation shows the types of data objects used (e.g., “employees” representing employee names or identifiers and “sales performance”), with the processing criteria used for sorting and ranking. Unlike a simple summary, which may omits criteria data types used or criteria applied, the interpretation statement can be a restatement or description of the data processing instructions (e.g., a structured query language (SQL) statement) used to generate the results that the chatbot used to provide its response.

The system can determine the interpretations of the chatbot for each user prompt based on code or instructions that an AI/ML model generates to retrieve data from a data source and/or calculate a result used in responding to the prompt. The system can facilitate this by using multiple interactions with the AI/ML model to answer each user prompt. For example, after a user prompt is received, a first interaction with the AI/ML model can be used to obtain data retrieval code or instructions, such as a SQL statement, that the AI/ML model generates. The data retrieval code or instructions can indicate, in a programming language or other standardized format, the operations or criteria for another system, such as a database system, to apply to retrieve the data that would be used in answering the prompt. The system can analyze the code or instructions generated by the AI/ML model to identify which portions (e.g., columns, rows, tables, etc.) of a source data set are referenced and how those portions relate to the terms in the user prompt. The AI/ML model can also be used to generate natural language text that concisely describes the data and operations represented in the code or instructions. The system can also use the generated code or instructions to retrieve or calculate the values that are needed to answer the user prompt. The system can then provide those values to the AI/ML model and request the answer to the original user prompt, which in many cases include a summary of or analysis of the results that the database system provided based on the code or instructions that the AI/ML model provided earlier.

Operating an AI/ML chatbot or other AI/ML-enabled application with multiple stages of interactions with AI/ML models can provide a number of advantages and benefits. For example, by using the AI/ML model to produce code or instructions, e.g., SQL content, the system obtains clear insight into the interpretation of the AI/ML model of the natural language content of the user's prompt. In addition, by requesting a response with a structured or standardized format, such as SQL content, the interpretations of the chatbot are well-defined and have much less ambiguity than a natural language chatbot response would often provide. When making the request to the AI/ML model, the system can provide the chatbot a data model or data schema for the data source(s) from which to retrieve data. The resulting code or instructions can thus reference specific data objects (e.g., particular logical data objects such as metrics, attributes, facts, etc., which may correspond to data sets, data tables, columns, rows, fields, etc. included in or derived from an underlying data set) with particularity, which can often show a distinct mapping or correspondence to a discrete portion of a data set. In addition, with the code and instructions generated by the AI/ML model, the system can retrieve and calculate values that are often much more accurate than if the AI/ML model attempted to provide the values.

The system can identify and provide many different types of interpretations of AI/ML models to users. For example, the system can provide information that indicates which data element(s) from a data source are selected or mapped to represent terms or phrases in the user's prompt or request. As an example, when processing a user prompt “show me stores with top sales this year from our sales data,” the system can detect that the AI/ML model interpreted “our sales data” to refer to a particular attribute or metric available from a data table in a database, the AI/ML model interpreted “stores” to be values of a store identifier attribute, and the AI/ML model interpreted “sales” to be amounts of gross revenue represented as a particular fact or metric. The system can also provide information that indicates the types of calculations used to generate results (e.g., functions, equations, expressions, algorithms, operations, or procedures used to generate or calculate results). For example, a user prompt may request and/or a chatbot response may include a result that is derived from a source data set but is not included directly in the data set. This may include values that aggregate data across rows of a table (or across tables or other data elements), values that are calculated based on values from multiple columns, values that are selected or filtered according to some criteria, or are otherwise the result of manipulating data. As a result, if the result involves a metric that is a calculated from a data set, the system show the user how the metric is defined, potentially with an equation or expression that indicates the operations that the AI/ML model selected for obtaining the values for the metric. The system can provide other types of interpretations also, such as a semantic meaning for a term or phrase or a selected meaning for a term if there are multiple possible meanings. In some cases, if the interpretation of a term is selected from a knowledge base, or if there are competing definitions or interpretations from different sources, the system can indicate the selected interpretation and its source.

The computer system can support interactive applications where processing tasks for responding to a user prompt are split between non-AI/ML or non-probabilistic data processing systems (e.g., database management systems) and AI/ML models. For example, when a user prompt such as a natural language query is received, the computer system can use a database system to generate a set of result data that is relevant to the user prompt. The set of result data can then be processed using one or more AI/ML models, such as a large language model, to generate content to present in a response to the user. This system can combine the strengths of AI/ML models and non-AI/ML processing systems to provide a chatbot or other application with responses that are more complete, accurate, and reliable than either type of processing system on its own.

In general, many AI/ML models have excellent generative capabilities and the ability to produce high-quality natural language output. However, AI/ML models also often have significant limits. For example, AI/ML models typically use probabilistic processing, which may generate responses that are generalized or approximate, and so may not adequately answer a user's question or may lack the accuracy or precision needed. In some cases, AI/ML models provide content that includes hallucinations or other information that may be statistically plausible given training data but is actually factually incorrect. The probabilistic nature of AI/ML models can also result in the same user prompt resulting in significantly different responses at different times, which can decrease users' confidence and ability to rely on the responses. For example, the same question may yield different numerical answers when the question is asked multiple times to an AI/ML model, even when the source data set has not changed.

As discussed further below, the computer system can provide chatbots and other interactive applications that combine the advantages of AI/ML models and the reliability and accuracy of other non-AI/ML or non-probabilistic data processing systems, such as relational database systems. Database management systems and other systems can reliably provide result data that is accurate and reliable, calculated from the source data using proven and validated processes. For example, data processing systems can be used to search a data set and make calculations, perform aggregations, and generate values in a data series in a repeatable or deterministic manner. This can be done even over large data sets, which may be much larger than an AI/ML system can accept as input context. In addition, the processing can be focused on the specific data set of interest, without extraneous data influencing the calculations as might occur in the probabilistic processing of an AI/ML model trained on large quantities of other data.

When the interactive application is used to respond to a user prompt, the non-AI/ML data processing system (e.g., a database management system) generates result data relevant to the user prompt (e.g., user's question) from the source data set. The user prompt and the result data set, potentially with other information and context, can be provided to the AI/ML model to generate text output for the response to the user. For example, the computer system can send a request for the AI/ML model to summarize the result data set or to generate a response to the original user prompt from the result data set that has been generated. As a result, the text that the AI/ML model generates can draw from values calculated accurately from the source data set, without requiring the AI/ML model to be capable of generating those values itself or without the AI/ML model even accessing the data set. As a result, the output to the user combines the reliable, accurate calculations from the non-AI/ML system with the text and other information provided by the AI/ML model from the result data set.

Combining the processing of AI/ML systems and non-AI/ML systems in the chatbots enhances privacy by limiting the amount of data that the AI/ML model or any other third parties receive. This can provide users with higher confidence in using the system, as well as allow the use of a wider range of third-party AI/ML service providers. When processing queries relating to a data set, the AI/ML model does not need to receive the full contents of the underlying dataset that the chatbot is based on. Indeed, in many cases, the AI/ML model does not receive even portions of the actual dataset, and instead receives only metadata describing the general contents and/or structure of the data set (e.g., types of metrics and attributes, semantic meaning of the columns, etc.) and potentially sample data (e.g., fictitious examples that illustrate the type of content in the dataset without revealing the actual values and records). In addition to enhancing privacy, this also increases speed and reduces network transfer requirements, since the dataset does not need to be sent over a network and the dataset itself does not need to be processed by the AI/ML model. The process also allows the data processing system (e.g., an enterprise database management system) to reliably apply security policies and access control over the dataset that the AI/ML model typically would not be capable of applying. After the data processing system performs processing to generate a result data set, the AI/ML model is provided the result data set and asked to generate a summary. In this interaction, the AI/ML model receives the result data set that generally includes aggregated or composite information specifically answering the user's question, and the AI/ML model does not receive access to the underlying dataset itself. As a result, the system avoids granting the AI/ML model- and any third-party providing the AI/ML model as a service-access to portions of the dataset that are not appropriate for answering the current question.

In general, splitting response generation among multiple processing systems, e.g., an AI/ML model and a database management system, increases the quality of output and control over the process of generating responses. The arrangement also facilitates customizability by allowing administrators to select different AI/ML models and different AI/ML service providers to customize their chatbots. With the system performing discrete operations leveraging AI/ML models, separate from the core querying of an enterprise's proprietary datasets, the chatbots can be more easily integrated with the processing capabilities of third-party systems.

In one general aspect, a method performed by one or more computers includes: receiving, by the one or more computers, a prompt from a user; obtaining, by the one or more computers, code or instructions generated by one or more artificial intelligence or machine learning (AI/ML) models, wherein the code or instructions specify criteria to retrieve data from a data source to respond to the prompt; generating, by the one or more computers, a set of results from the data source based on the generated code or instructions; obtaining, by the one or more computers, a response to the prompt that the one or more AI/ML models generate using at least a portion of the set of results; generating, by the one or more computers, an interpretation statement that indicates how the prompt was interpreted by the one or more AI/ML models; and providing, by the one or more computers, output that includes (i) the response to the prompt and (ii) the generated interpretation statement.

In some implementations, the one or more AI/ML models comprise a large language model (LLM).

In some implementations, the interpretation statement comprises a summary or description of information that the code or instructions are configured to obtain from the data source.

In some implementations, the interpretation statement indicates data objects or criteria used to retrieve the set of results.

In some implementations, the interpretation statement indicates at least one of (i) a mapping between one or more terms of the prompt to one or more corresponding data objects, wherein the mapping was determined by the one or more AI/ML models, or (ii) one or more formulas or equations that indicate how a portions of the set of results was calculated.

In some implementations, providing the output comprises providing output that causes a particular term of the prompt to be annotated or visual distinguished from other terms in the prompt; and the interpretation statement designates an attribute, metric, or other data object that is interpreted to represent the particular term.

In some implementations, the code or instructions comprise a structured query language (SQL) statement.

In some implementations, the code or instructions comprise executable or interpretable code.

In some implementations, the code or instructions include data filtering parameters or data aggregation parameters for generating the set of results; and the interpretation statement indicates the data filtering parameters or data aggregation parameters.

In some implementations, obtaining the code or instructions comprises providing, to the one or more AI/ML models, a data model or data schema for one or more data sources, wherein the code or instructions include references to data objects in the data model or data schema; and the interpretation statement includes references to the data objects in the data model or data schema.

In some implementations, the interpretation statement is generated by analyzing the code or instructions together with a data model or data schema for the data source.

In some implementations, the interpretation statement comprises text generated by the one or more AI/ML models in response to a request to summarize or explain interpretations used in the generated code or instructions.

Other embodiments of these aspects include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue having instructions that, when executed by data processing apparatus, cause the apparatus to perform the actions.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIG. 1 is a diagram showing an example of a system for determining and revealing interpretations made by artificial intelligence or machine learning (AI/ML) models.

FIGS. 2-4E are diagrams showing examples of user interfaces that display interpretations made by artificial intelligence models.

FIG. 5 is a flow diagram that describes a process for determining and revealing interpretations made by AI/ML models.

FIGS. 6A-6D show example user interfaces showing functionality for showing natural language insight derived from visualization data and other content.

Like reference numbers and designations in the various drawings indicate like elements.

### DETAILED DESCRIPTION

In some implementations, a computer system includes features to present users with interpretations made by AI/ML models. For example, the system can reveal execution steps for handling user requests to a chatbot or other AI/ML functionality. By determining the interpretations made by AI/ML models and showing users the interpretations, the system can demystify AI/ML decision-making processes and foster user trust. The system can be implemented to provide users with a clear and concise view of how their questions are interpreted, processed, and answered by AI systems.

In some implementations, the interpretation information provided to users is adapted to or is customed for the needs of different users or user groups. For example, a concise, simplified view can be provided for some classes of users, such as those with limited privileges (e.g., read access or view access only) for accessing a document, data set, or application. A more detailed view can be provided for users with greater privileges (e.g., users with read and write access).

One way that the system and provide an interpretation is by clearly articulating or restating the user's prompt to reflect how the AI/ML model has interpreted the user's question. This type of interpretation is very helpful for business users, new users, or those with limited privileges (e.g., read only access), who may appreciate a natural language description. This type of restatement or summary can affirm the logic and criteria used to generate the response. This restatement aims to eliminate ambiguities and present the query in its most straightforward form. The system can be implemented so that if a user copies and pastes the reinterpretation of the user query back into the chat, the AI/ML chatbot will produce the same or extremely similar results, thereby demonstrating the consistency and reliability of the AI's understanding. As an example, a user may enter a prompt such as “Show the top 5 performing employees in terms of sales,” and this can be interpreted as: “Top five employees ranked by sales performance, sorted in descending order.” This approach ensures users understand which metrics are chosen to answer the prompt and shows how the prompt is processed. The system can generate this type of interpretation by extracting information from code or instructions (e.g., SQL content) generated by an AI/ML model. In some implementations, the AI/ML model can be used to generate this summary or restatement. For example, the system can ask the AI/ML model to provide a concise description of the AI/ML model's interpretation of the user prompt or a concise description of the SQL the AI/ML model generated based on the user prompt.

The system can also provide more detailed insights about the execution of data processing operations used to answer the user's prompt to an AI/ML chatbot. For example, for power users with sufficient privileges (e.g., edit privileges for a document or dashboard) such as data analysts, data architects, and IT professionals, the system can offer in-depth insights into the interpretations made by AI/ML models and used in constructing visualizations. These interpretations can include mappings of data objects used, placed under the text restatement of the user's prompt. This can include displaying filtering conditions, attributes, metrics, derived objects, sorting operations, and advanced analytics steps used in the process of generating the final response from the chatbot, enhancing transparency for those who need to validate and fine-tune AI responses. For example, the system can indicate data objects used (e.g., data tables, columns, rows, etc.) and how the data objects correspond to terms or phrases in the user prompt.

In many cases, generating a chatbot response involves multiple stages of processing or includes intermediate steps or data before arriving at the final response. For example, an AI/ML model may generate a SQL statement that generates one or more intermediate tables or sets of results that are then further processed to obtain the final results. These intermediate results are usually hidden and not shown to users, but the system can store them and make them available to users to show the processing steps used to reach the final chatbot response. In some implementations, the system may use a module that generates hidden visualizations for intermediate results, and those visualizations (and/or the data that would be represented in those visualizations) can be made available to users.

Additionally, a discrete icon can be provided available, enabling power users to access and copy the code or instructions from the AI/ML model, which can be in the form of an SQL statement generated by a LLM. As discussed further below, a chatbot or other application can be structured to first request generation of code or instructions for retrieving and processing data, and then the code or instructions can be executed or used to generate the data from a data retrieval system, such as a database management system. Providing users access to the code or instructions generated by an AI/ML model is particularly useful for validation and troubleshooting purposes, allowing power users to determine if discrepancies in responses stem from the LLM's SQL generation or the subsequent visualization construction process performed by other software modules.

As an example, a user may provide a prompt such as “What are the Revenue, Profit, & Profit Margin for every Category, Subcategory in the last 2 years for the Region that have Cost more than $100?” The system can indicate the interpretation of the prompt by indicating the objects in a data set that are selected to represent the items the user mentioned. For example, based on output of the AI/ML model, such as a SQL statement or a request for the AI/ML model to specify the data objects used, the system can determine and show that (1) attributes used include a ‘category’ and a, (2) metrics used include quantities revenue, profit, and profit margin, (3) applied filters include ‘Year: 2021, 2022’ and ‘Cost >100.’ These objects can be identified and displayed to the user so the user can validate and understand the AI's logic in processing the user's prompt.

In some implementations, the system provides user interface controls with or as part of the chatbot response display, for users to provide feedback about the interpretations made and shown. For example, a thumbs up and/or thumbs down icon can be provided, so the user can signal whether the interpretation matched the user's intent when writing the user prompt. Incorporating AI interpretation and execution insights alongside the user feedback mechanism significantly enhances the effectiveness. It is particularly valuable when users give negative feedback, e.g., a thumbs down rating. The feedback and context can be saved and provided to authors of documents and chatbots, so authors can see the user's question and the AI/ML model's interpretation. This insight is very helpful for pinpointing misunderstandings or inaccuracies and taking targeted steps to enhance the system's responses and accuracy.

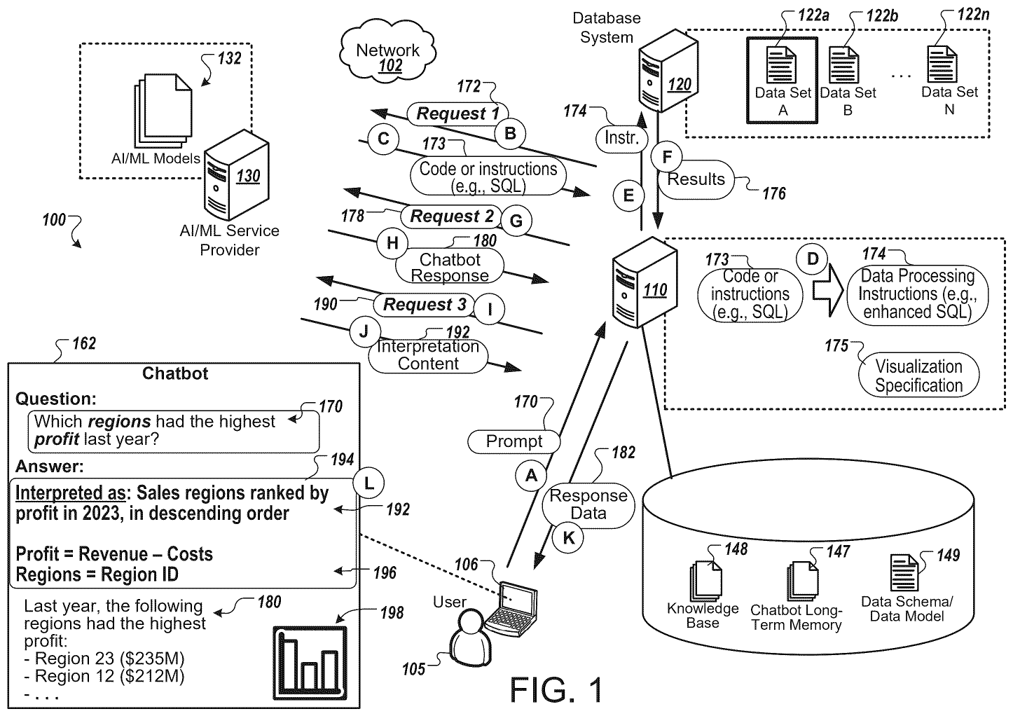

FIG. 1 is a diagram showing an example of a system 100 for determining and revealing interpretations made by artificial intelligence models. The system 100 includes a computer system 110, a database system 120, and an AI/ML service provider 130. The system also includes a user device 106 of a user 105. The elements of the system 100 communicate over a network 102, such as the Internet. The computer system 110 coordinates a variety of operations to provide and manage access to chatbots and other AI/ML applications. In the example, the user 105 enters a user prompt 170 for a chatbot, and the computer system 110 coordinates the generation of the answer by the chatbot, including a text response 180 generated by an AI/ML model 132, a data visualization 198, and accompanying interpretation information 194 that indicates how the AI/ML model 132 interpreted the user's prompt 170. The example of FIG. 1 includes stages (A) to (K), which represent various operations and a flow of data, and which can occur in the order illustrated or in a different order.

The computer system 110 can produce chatbot answers with high accuracy and high reliability by generating the chatbot's response to the prompt 170 using multiple interactions with the AI/ML model 132. For example, the computer system 110 sends a first request 172 that requests that the AI/ML model 132 generate code or instructions 173 for retrieving and/or calculating values for answering the prompt 170. The first request 172 can request that the response be provided in a standardized format, such as structured query language (SQL) or another programming language. The computer system 110 then uses the code or instructions 173 (or a modified version shown as data processing instructions 174) to retrieve results 176 from one or more data sets of the database system 120. The computer system 110 can then send the results 176 from the database system 120 to the AI/ML model 132 in a second request 178 to generate a response (e.g., a chatbot text response) to the prompt 170 that is based on the results 176. The computer system 110 can send a third request 190 to the AI/ML model 132 that requests a text statement of the interpretation of the prompt 170 and/or the operations or criteria used to respond to the prompt 170. For example, the third request 190 can be a request for the AI/ML model 132 to generate a concise natural language description of the data processing instructions 174 (e.g., a SQL statement) used to generate the results 176. In this manner, an LLM or similar model can be used to translate from code or instructions for retrieving data to a user-readable text statement of the criteria or operations used to generate the results 176 from the database system 120 used in providing the chatbot's response.

The computer system 110 can be implemented using one or more servers, such as one or more cloud computing systems, one or more on-premises servers, etc. For example, the computer system 110 can be an application server. The computer system 110 provides front-end functionality to interface with various client devices. For example, the computer system 110 can provide an interface for creating and editing chatbots and other interactive applications that leverage AI/ML models. The interface can be an application programming interface (API), a user interface (e.g., by providing user interface data for a web page or web application), or another type of interface. The computer system 110 performs various other functions to generate and save customized chatbots, to manage and grant access to existing chatbots, and to coordinate the processing of user prompts to generate responses from the chatbots.

The database system 120 can provide various data retrieval and processing functions. For example, the database system 120 can be a database management system (DBMS), and can include the capability to process operations specified in structured query language (SQL), Python code, or in other forms. The database system 120 has access to various datasets 122a-122n, which can be private datasets for organization, such as a company. The database system 120 can store and use datasets in any of various forms such as tables, data cubes, or other forms.

The AI/ML service provider 130 can be a server system or cloud computing platform that provides access to one or more AI/ML models 132, such as LLMs. The computer system 110, the database system 120, and the AI/ML service provider 130 may be implemented as separate systems or may be integrated in a single system. For example, the AI/ML service provider 130 can be a third-party service or can be managed and operated by the same party as the computer system 110 and/or the database system 120.

Chatbots can be provided by the computer system 110 or other systems, including third-party systems. Some or all of the chatbots may be executed or managed by the same server system or same operator as the computer system 110. Each chatbot can have an associated dataset 122a-122n (or multiple datasets) from which the chatbot derives responses to user. Each chatbot can also have a corresponding AI/ML model 132 designated to use for generating responses from the chatbot, such as a LLM. Each chatbot can also have a corresponding set of settings and customizations that specify various properties of the chatbot (e.g., text output tone and style, output format, verbosity, etc.). Different chatbots may use different datasets 122a-122n or share the same datasets 122a-122n, and similarly different chatbots may use different AI/ML models 132 or share the same AI/ML model 132. Each chatbot can also include functionality to store conversation histories for each user across different sessions of use. In other words, for the user 105, each chatbot can store a separate, persistent chat history for the interactions of the user 105.

Different users have access to different datasets 122a-122n and chatbots 108a-108n, depending on their roles, permissions, etc. The user 105 authenticates to the computer system 110, so that the user's identity is determined and the user's permissions can be determined.

In the example of FIG. 1, in stage (A), a user 105 enters a prompt 170 in a chat user interface 162, and the client device 106 of the user 105 sends the user prompt 170 to the computer system 110 over the network 102. The user 105 accesses a chat user interface 162 for interacting with AI/ML chatbots using a user device 106 (e.g., a phone, a laptop computer, a desktop computer, etc.). For example, the chat interface 162 can be part of a web page, a web application, a native application on the user device 106. The chat interface 107 can be displayed based on user interface data provided by the computer system 110 or another server. The user 105 interacts with the chat interface 107 to enter a user prompt 111, which in this example is the question, “What is the typical response time for new technical support tickets?” The user 105 has previously been authorized to access multiple chatbots, in this case, all of the chatbots 108a-108n. Before submitting the user prompt 111, the user 105 has logged in and authenticated, so the computer system 110 is aware of the identity of the user 105 and can grant and limit access based on the user's permissions.

Various techniques can be used to identify one or more data sets 122a-122n that are relevant to the prompt 170. In some implementations, the chatbot that the user 105 converses with has a specific set of one or more data sets 122a-122n associated with it, and these data sets can be identified to the computer system 110 or be pre-associated with the particular chatbot. In some implementations, the chatbot interface 162 can be integrated with or provided alongside another interface region, such as a viewing area displaying a document, dashboard, or other content. The data set 122a-122n used to respond can vary based on the document or content that is active (e.g., being viewed, edited, etc.). For example, one or more data sets 122a-122n that are relevant to the user's current context can be identified based on the document or other content being displayed, so that if a document section being viewed includes content derived from a particular data set 122a, that data set is identified and indicated to the computer system 110. In some implementations, the relevant data set(s) 122a-122n are indicated earlier in the conversation history or are explicitly set by a user interacting with a user interface control. In some implementations, the computer system 110 itself selects which data sets to use, from among different data sets 122a-122n, based on access permissions of the user 105 and/or the topics or keywords in the prompt 170.

In stage (B), the computer system 110 generates and sends a first request 172 to the AI/ML service provider 130 based on the prompt 170. The first request 172 can be a request for data retrieval code or instructions, e.g., a request for an LLM to generate a SQL statement or other criteria for retrieving and/or generating data from a data set. The first request 172 can include some or all of the prompt 170. The first request 172 can also include information about the types of data available in the data set 122a, such as a data model 149 or data schema for the data set 122a.

The first request 172 can be a request for an AI/ML model 132, such as an LLM, to generate code or instructions for a system (such as the database system 120) to use in retrieving and/or generating data to answer the prompt 170. For example, rather than asking the AI/ML model 132 to generate the answer to the prompt 170, the first request 172 can request a SQL statement, programming code, a list of operations, or other instructions that specify criteria that would retrieve and/or calculate the values needed to answer to the prompt 170. As a simple example, the prompt to the LLM in the first request 172 may include an instruction such as “provide a SQL statement that retrieves the data needed to answer the question <<user prompt>>,” or “generate Python code that can run on <<database system>> to calculate the answer to the question <<user prompt>>.”

In the example of FIG. 1, the relevant data set 122a for the chatbot conversation is “Data Set A,” illustrated as data set 122a. In response to the prompt 170, the computer system 110 generates the request 172 to include text instructions to an LLM such as, “Generate a SQL statement to retrieve from Data Set A the data that answers ‘Which regions had the highest profit last year?’” As a result, the first request 172 can be a request for a SQL statement or Python code that, when interpreted or executed by another system such as the database system 120, that specify the criteria for the other system to retrieve and/or generate values (e.g., a result data set) derived from a data set 122a-122n that can provide the information needed to answer to the prompt 170.

By requesting code or instructions, the process takes advantage of the ability of AI/ML models 132 to reliably produce high-quality code or instructions expressed in programming languages (e.g., SQL, Python, Java, HTML, XML, etc.). This often generates in a more concise and unambiguous result than more free-form text outputs. This type of request guides or constrains the AI/ML model 132 to follow the conventions of a particular programming language (which can be specified in the request 172). Programming languages are usually designed to avoid ambiguity and to promote consistency in usage of terms across many different situations. As a result, code examples often demonstrate clear usage patterns that the AI/ML models 132 can learn from and follow.

Also, by requesting that the AI/ML model 132 create the code or instructions using a standardized format, such as SQL, this greatly increases the number of different AI/ML models 132 that can be used with the system. For examples, many different LLMs may have a capability to create SQL, while models, if any, may be able to reliably generate visualizations or descriptions of visualizations. With many different options for selecting an AI/ML model 132 to create SQL, the computer system 110 has the versatility to vary which AI/ML service provider or model is used (e.g., for cost, speed, load balancing, etc.) and the robustness to change which model is used if a AI/ML service provider or model becomes unavailable.

Requesting that the AI/ML model 132 create code or instructions for data retrieval takes advantage of strengths of LLMs, such as natural language interpretation of the user's prompt 170 and ability to generate text, such as code, that follows established patterns or rules. This also constrains the constrains the form of the output to a set of code or instructions, such as SQL or another standardized representation, which allows the high-quality results to be achieved reliably.

To enable the AI/ML model 132 to reference the appropriate logical data objects of the relevant data set 122a (“Data Set A”), the first request 172 includes the data model 149 for the data set 122a to be used. The data model 149 can include information about the data set(s) that the chatbot will use to respond to the request 172, usually without providing any of the actual content of the data set. For example, the data model 149 can include a data schema for the data set 122a. In general, the data model 149 can indicate a list of logical objects represented in the data set 122a, such as a list of the elements or components of the data set, such as metrics, attributes, facts, and so on. For example, the data model 149 can indicate that the data set 122a includes logical objects such as date, customer identifier, region code, sales amount, and so on. These data objects can represent quantities or data objects that are represented in, or can be derived from, data in the data set 122a. The logical objects, such as metrics or attributes, can represent the type of data that is stored in or derived from a column of data. For example, an attribute may represent a type of data stored in a column of a data table or the result that would be obtained by applying a particular arithmetic expression to data in a column. Similarly, a metric or fact can represent the result of applying a particular aggregation function or other operation(s) to values in one or more columns of a data table. Accordingly, the data model 149 can indicate the attributes and metrics that are available for the AI/ML model 132 to work with, and potentially additional attributes or metrics that can be generated or operations that are available for the database system 120 to create a new attributes or metrics.

In some cases, the data model 149 can indicate, through the logical objects identified, data from tables, columns, and other elements that make up the data set 122a, in addition to or instead of the semantic meanings and/or relationships among these elements of the data set 122a. For example, the data model 149 can indicate that the data set 122a includes set of data named “sales_table,” that includes a metric named “sales_amount” that indicates amounts of sales and another attribute named “region” that indicates the region in which the sale occurred. These quantities may or may not correspond directly to the structure of the data set 122a. For example, the item “sales_table” may be an actual data table of a database, or may not represent a table and instead another grouping of data. Similarly, the “sales_amount” and “region” objects may correspond to specific columns of a data table, but may alternatively represent values that can be calculated or otherwise derived from the data set 122a in another way. Providing the data model 149 can give the AI/ML model 132 a list and description of the logical objects that the database system 120 recognizes, so that code or instructions generated by the AI/ML model 132 can use the identifiers known to the database system 120 and/or the computer system 110. As a result, the AI/ML model 132 can generate code or instructions that reference these logical objects that are understood by the computer system 110 and the database system 120. To the extent that the objects indicated in the data model 149 differ from the actual structure of the data set 122a, the computer system 110 and the database system 120 can use convert from the logical object names used in the data model 149 to actual data set elements and functions.

The data model 149 can indicate the names or labels for these data elements, classifications of the elements (e.g., metric, attribute, etc.), and other information. In some implementations, the data model 149 can include sample data for the data set 122a, such as a sampling of data from the data set 122a. The sample data can be fictitious example data that may be artificially synthesized to be representative of the data in the data set 122a (e.g., similar types of data), without indicating actual contents of the data set 122a. The data model 149 can be provided in any of various forms, such as a database schema from a database management system, a list or definitions of objects, components, or identifiers of the data set 122a, etc.

By providing the data model 149 with the request 172, the computer system 110 provides the AI/ML model 132 the ability to make use of the logical objects specified in the data model 149. As a result, the AI/ML model 132 can determine the types of data that would be available from the data set 122a, even without the AI/ML model 132 having any access to the data set 122a. The AI/ML model 132 can generate code or instructions (e.g., a SQL statement) that references these logical objects, with a clear set of names or other identifiers to accurately and unambiguously reference components of the data set 122a. For example, providing the data model 149 for the data set 122a, may enable the AI/ML model 132 to reference logical objects in generated SQL statements that the computer system 110 and/or database system 120 can unambiguously map the logical objects to tables and columns of the data set 122a. This allows the AI/ML model 132 to distinctly and unambiguously define criteria to specify the subset or portion of data to be retrieved from, or calculated based on, the data set 122a.

In some implementations, the first request 172 includes additional information that assist the AI/ML model 132 to interpret and respond to the user prompt 170 and other information, such as a knowledge base 148. The knowledge base 148 can provide a mapping for the AI/ML model 132 to map words and phrases with non-standard or idiosyncratic meanings (e.g., jargon, nicknames, etc.) to definitions, descriptions, or other indications of their meaning. The knowledge base 148 can include information determined at any of multiple levels, such as at the level of an enterprise as a whole, for a department or group of individuals, or for a specific individual. Similarly, the knowledge base 148 can be one that has been created for a single chatbot or AI/ML application or one that is shared with multiple chatbots or AI/ML applications.

In some implementations, the computer system 110 enables the administrator 103 to attach one or more additional data sets to adjust the operation and output of the chatbot. For example, an additional data set can be a knowledge base 148 or data dictionary can be added. Unlike the primary data set that the user selects for the chatbot (e.g., data set 122a), the chatbot is not configured to answer questions about the additional data set or to retrieve metrics or to provide visualizations of the knowledge base 148. Instead, the knowledge base 148 can be provided to assist the chatbot in interpreting user queries and providing responses with the terminology for the user's organization. In general, the knowledge base 148 can function to provide contextual knowledge to the AI/ML models 132, so the models can classify and use the nomenclature of the end user when generating answers to user prompts.

Many different organizations or departments use terms that have a special contextual meaning, or are not part of general language, and so would not be available for training of an LLM. For example, a company may internally use various names for its products, projects, teams, locations, policies, initiatives, organizational structure, and so on. For example, a company be developing a product with a codename of “starfish” that being developed by a group of employees called “red team.” The training state of an LLM would not incorporate information about these entities, which are specific to the company and not referenced in public documents. To enable the chatbot to process questions about these internal entities and provide answers that reference them, a knowledge base 148 is designated for the chatbot to describe these and other internal terms. Each time the user submits a prompt, the knowledge base 148 can be provided to assist the LLM with the context that is appropriate for the company. The knowledge base 148 can provide information similar to a semantic graph, by describing entities and their relationships. In some cases, the information in the knowledge base 148 can be derived from a semantic graph 150 and then converted into text (e.g., unstructured, semi-structured, or structured) in a format that can be processed by the LLM.

In general, the knowledge base 148 or other additional data set can include data that maps terms or phrases to their meanings. In many cases, this can include semi-structured data or explanatory content, as a way to explain entities and relationships wo the AI/ML models 132. Although the knowledge base 148 may include definitions, more generally the information may include descriptions of people, roles, business units, products, and other terms that may be referenced. The administrator 103 may upload one or more of additional data sets and specify which additional data sets, if any, should be used to provided context for a chatbot. The data sets selected for this contextual function can then be used to provide context for all prompts and responses of the chatbot.

In some implementations, the contextual data sets or knowledge bases can be applied so that they apply to multiple chatbots. For example, an enterprise can designate one or more knowledge bases 148 as contextual data sets that can be applied consistently across the enterprise, for all chatbots created and used in the enterprise. Similarly, different departments within the enterprise may add their own particular contextual data sets that may supplement the enterprise-wide knowledge bases 148. In addition, specific contextual data sets can be added for specific chatbots. In this way, chatbots at different levels of an organization can inherit a consistent set of terminology and knowledge in an organization, which also makes maintaining the overall knowledge base much more simple. The knowledge bases 147 can additionally or alternatively be specified with a scope that corresponds to a computing environment, so that chatbots associated with a particular domain or server inherit the knowledge bases for that domain or server.

One of the advantages of the knowledge base 148 is consistency for many users and even for many different chatbots of an organization. The user submitting a prompt does not need to take any action to select or include the knowledge base 148 in the chatbot's processing, the chatbot automatically include the knowledge base 148 in its context for each prompt or question received. Also, because the knowledge base 148 can be shared or inherited by many chatbots within an organization, updating and maintaining the knowledge base 148 is simple. An edit to the knowledge base 148 is automatically applied to all of the chatbots associated with the organization, even if the chatbots were created by different administrators or provided to different sets of users.

In addition, the knowledge base 148 provides persistent context that is not lost from one prompt to another or from one session to another. The knowledge base content can also be implemented applied in a manner that the knowledge base 148 does not count toward the instruction token limits that the AI/ML models 132 consume for each response. Rather than counting toward the tokens for prompts and recent history, the knowledge base 148 can be accessed or provided to the AI/ML models 132 as a separate source of knowledge apart from the prompt and context, and so does not count toward the token limits of an LLM. Implementations of access to the knowledge base 148 can vary. For example, when a session with the chatbot is instantiated, the knowledge base can be provided as part of initializing the chatbot. In some cases, the AI/ML models 132 are additionally or alternatively configured to access the primary dataset and if the user prompt includes a term or makes a request for an item not specified in the primary dataset, the chatbot is configured for the AI/ML models 132 to then check the knowledge base or other contextual data sets. In some implementations, the knowledge base 148 can be prepared as an embedding, a vector database, or other format that can be accessed by or referred to by the AI/ML models 132.

The first request 172 can include additional information such as a conversation history for the user 105 and the chatbot, and/or a long-term memory 147 with information that persists across chat sessions. The history or memory 147 can represent any of various types of information that can be stored external to the AI/ML models 132 but captures information about previous sessions, previous conversations or previous text of the current conversation, preferences of one or more users, learning from feedback of one or more users, and so on. In some implementations, the chatbot is designed to have a long-term memory 147, which can store information learned from users in past interactions. For example, LLMs and other AI/ML models 132, on their own, are generally stateless and do not natively understand the user context or history of interactions with the user, especially from previous sessions. The computer system 110 can facilitate learning by the chatbot to provide infrastructure that creates a long-term memory 147 for the chatbot. For example, the long-term memory 147 can store items such as definitions of terms for a particular user context, unique text elements the chatbot might encounter, and feedback from prior user interactions.

One valuable aspect of the long-term memory 147 is the ability for the chatbot to learn and adapt from explicit or implicit user feedback over time. If a user asks questions, then gives feedback they were expecting something different (e.g., either through text of a prompt to the chatbot or through an external survey or rating), then the computer system 110 can capture that feedback and update the chatbot to better provide what the user intended in the future. For example, the computer system 110 may add or adjust the instructions to the chatbot to reflect the user expectations or preferences. In some cases, this may include changing the default response format or response instructions, or may include adding rules or explanations that are context-dependent (e.g., apply to specific phrases or prompt types). This learning may occur at different levels. For example, it may include learning that particular terms, phrases, or combinations of terms call for a particular type of response. As another example, the feedback may more shift answers generally in certain ways, e.g., to be more verbose, more concise, to add or change visualizations, to change the order of content, to add or adjust summary elements, and so on.

In stage (C), the AI/ML service provider 130 uses one or more of the AI/ML models 132 to generate a response to the first request 172. The AI/ML service provider 130 then sends the response, code or instructions 173, to the computer system 110. As discussed above, the first request 172 requests code or instructions specifying the criteria or data processing operations that can be used to retrieve and/or generate (e.g., calculate) from the data set 122a the result data that would be needed to answer the user prompt 170.

In response to the request 172, the AI/ML service provider 130 uses the AI/ML models 132 to generate the code or instructions 173 that specify the criteria to retrieve and/or generate the data needed to answer the prompt 170. This part of the process leverages the ability of the AI/ML models 132, e.g., LLMs, to generate a set or sequence of instructions or operations. The data processing instructions 174 can be expressed in any of a variety of ways, such as one or more SQL statements, as executable or interpretable code, such as Python code, as a list of API calls or commands to be executed, and so on. The code or instructions 173 can provide instructions for retrieving specific portions of one or more data sets, such as from the specific data set 122a specified in the prompt 170 or otherwise indicated to the AI/ML model 132 used. The code or instructions 173 can additionally or alternatively instruct various data processing steps or operations to be performed, including data joins, data aggregations, filtering data, evaluating expressions, creating new metrics and calculating their values, etc.

As an example, in response to a request 172 that included an instruction, “Generate a SQL statement to retrieve from Data Set A the data that answers ‘Which regions had the highest profit last year?,’” the code or instructions 173 generated by the AI/ML model 132 can be a SQL statement such as the one below:

```
WITH Profit_Calculation AS (
  SELECT region_name, SUM(sales_amount − costs) AS total_profit
  FROM Data_Set_A
  WHERE YEAR(date_attribute) = YEAR(CURRENT_DATE) − 1
  GROUP BY region_name
)
SELECT region_name, total_profit
FROM Profit_Calculation
ORDER BY total_profit DESC
LIMIT 10;
```

In this example, the generated SQL statement can refer to logical data objects, which may or may not correspond to actual columns of data stored in the data set 122a. Based on the data model 149 and the logical objects it specifies to be available (and those that are omitted), the AI/ML model 132 generates output that refers to the object “date_attribute” indicating the date of entries, the object “region_name” which indicates the names of the regions, an object “sales amount” that indicates sales amounts, and “costs” that indicates costs. Because the data model 149 does not indicate that the data set 122a includes a “profit” object, the generated SQL statement specifies to calculate profit values from the “sales_amount” and “costs” object and give the result the label “total profit.”

In stage (D), the computer system 110 uses the code or instructions 173 generated by the AI/ML model 132 to generate data processing instructions 174 to be processed by the database system 120. For example, the computer system 110 can analyze and update the code or instructions 173, such to modify the SQL statement from the AI/ML model 132 to an enhanced or improved SQL statement. As a result, the data processing instructions 174 can be a combination of code or instructions 173 from an AI/ML model 132 and changes or enhancements added by the computer system 110.

In some implementations, the computer system 110 examines the code or instructions 173, such as to verify or edit the code or instructions 173 as needed for compatibility or efficient processing by the database system 120. In some cases, the standardized format of the code or instructions 173 allows it to be provided directly to the database system 120 for execution or processing. In other cases, the data retrieval manager 144 may alter the code or instructions 173 or translate the code or instructions 173 to another form. For example, the data retrieval manager 144 can translate a generalized or standardized set of code, such as a SQL statement, into a more specialized or targeted form of data processing instructions 174 that makes use of the specific features of the database system 120. For example, the generated data processing instructions 174 can reference functions, commands, modules, application programming interfaces (APIs), or other features of that database system 120 that may go beyond or may not be supported in the more standardized code or instructions 173.

As another example, although the AI/ML model 132 has the data model 147 for the data set 122a in its context when processing the request 172, the resulting code or instructions 173 may include errors, such as incorrect identifiers for attributes, metrics, data sources, or other references to the data set 122a. The computer system 110 can examine and validate the code or instructions 173 to identify and correct errors in the syntax or structure of the SQL statement or other content present, and similarly update references to the data set 122a to generate a set of data processing instructions 174 that can be executed correctly by the database system 120. For example, the computer system 110 may apply a set of rules or validation checks to verify that the code or instructions 173 are valid and appropriate to be executed by the database system 120. For example, the computer system 110 can store rules or heuristics that can evaluate the data processing instructions 174 element by element and/or as a whole to verify and correct the code or instructions 173 if needed before they are sent to the database system 120.

In stage (E), the computer system 110 uses the data processing instructions 174 to instruct the database system 120 to obtain (e.g., retrieve, calculate, generate, etc.) the data needed to answer the user prompt 170. For example, the computer system 110 may send a request that includes the data processing instructions 174 to the database system 120, in order to request the needed data.

In stage (F), the database system 120 generates and sends results 176 that include the data retrieved from and/or generated based on applying the data processing instructions 174 for the dataset 122a. The database system 120 processes or executes the data processing instructions 174 that it receives, which creates the results 176, which may be in any of various forms, such as records retrieved, data series, aggregations of data, statistics about data in the dataset 122a, subsets of the dataset 122a determined to be relevant, and so on.

In the illustrated example, the user prompt 170 asks which regions had the highest profit over the last year. The data processing instructions 174 specify the criteria or operations needed to generate measures of profit by region for the previous year. For example, the data processing instructions 174 may include a SQL statement to retrieve these values, or may include a set of instructions in a programming language, such as Python. The results 176 generated by the database system 120 include the values needed to answer the question in the user prompt 170. In other words, the results 176 include values of profit for the regions specified in the dataset 122a, appropriately labeled or associated with identifiers for those regions.

In this process, the AI/ML models 132 have been leveraged to obtain the results 176, however, the AI/ML models 132 did not need or receive access to the dataset 122a itself, and the AI/ML models 132 did not incur the resource costs of having to process the dataset 122a. In addition, the database system 120 and its reliable, repeatable calculations ensure that the results 176 are accurate, without the AI/ML models 132 introducing uncertainty into the calculations. In addition, the dataset 122a may be very large, much larger than the maximum context length of an LLM used for the AI/ML model 132. In many cases, the amount of data in the dataset 122a may be orders of magnitude larger than the maximum context size that the LLM can process. The database system 120 can process a large data set much more quickly and with greater power efficiency than an LLM can. Also, due to limits on LLM context sizes, it may be impractical or impossible for an LLM to analyze the dataset 122a to generate the needed results 176.

In stage (G), the computer system 110 sends a second request 178 to the AI/ML service provider 130. The second request 178 includes the results 176 and requests that the AI/ML models 132 generate a response that answers the prompt 170 based on the results 176. For example, the second request 178 may be a request to answer the prompt 170 using the data in the results 176 as context. As another example, the second request 178 may be a request for the AI/ML models 132 to summarize the results 176, in addition to or instead of answering the user prompt 170.

As with the first request 172, the computer system 110 can provide user context data, a conversation history for the user 105, or other context information in or with the second request 178, so the AI/ML model 132 can generate a response based on the context of the user's situation and the user's previous conversations. The computer system 110 can also provide information from the knowledge base 148, the long-term memory 147, the data model 149, and so on.

In stage (H), the AI/ML service provider 130 uses the AI/ML models 132 to generate a response to the user prompt 170, e.g., a chatbot response 180 that includes natural language text providing the answer to the prompt 170 as determined from the results 176. For example, the second request 178 may include or provide access to the results 176 and the user prompt 170, and so the AI/ML models 132 generate a text response 180 to the prompt 170 from the values in the results 176. For example, in the illustrated example, the chatbot response 180 is text that one or more AI/ML models 132 generated that indicates the specific regions having the highest profit, as requested by the prompt 170, along with an indication of the profit values taken from the results 176.

In stage (I), the computer system 110 generates and sends a third request 190 to the AI/ML service provider 130. The third request 190 asks for the AI/ML model 132 to generate concise natural language text that expresses the operations or criteria used in responding to the user prompt 170. This can be done by providing the code or instructions 173 that the AI/ML model 132 generated based on the prompt 170, and asking for the AI/ML model 132 to concisely summarize or explain the code or instructions 173 that the AI/ML model 132 generated. In other words, the third request 190 can ask the AI/ML model 132 to translate a SQL statement that the AI/ML model 132 itself generated back into a natural language statement that expresses the type of result data that the SQL statement would generate. Thus, the system can use the AI/ML model 132 to interpret the user prompt 170 and convert it to code or instructions 173, and then use the AI/ML model 132 to interpret the code or instructions 173 and convert it to a natural language statement. This two-step process, converting from natural language to SQL then back to natural language, provides an effective way to obtain the interpretation applied by the AI/ML model 132, so it can provide transparency about how response content is generated. The third request 190 can provide guidance or limits for the response, such as to specify that all of the data processing criteria should be included, or to limit the length or form of the response to a single sentence or another specified limit.

The data processing instructions 174 used by the database system 120 to generate the results 176 are based on (e.g., derived from or are edited versions of) the code or instructions 173 from the AI/ML model 132, as discussed above. As a result, the interpretation of the code or instructions 173 can provide a useful description of the criteria used to generate the results 176, which in turn were used by the AI/ML model 132 to generate the chatbot response 180. If a visualization is generated in response to the prompt 170, the visualization is typically generated based on the same results 176. In some implementations, the third request 190 can provide the data processing instructions 174, in addition to or instead of the code or instructions 173, and can ask for a natural language statement describing or summarizing the code or instructions 173 or the data processing instructions 174 used by the database system 120 to generate the results 176.

The third request 190 can request that an AI/ML model 132 generate concise natural language text that expresses the operations or criteria of the code or instructions 173 (or the data processing instructions 174). In other words, the third request 190 can request for the AI/ML model 132 to translate the code or instructions 173, such as a SQL statement, into natural language text. For example, the third request 190 can include an instruction to an LLM, such as “Generate a concise statement that describes the data retrieved by the following SQL statement,” together with the SQL statement used as the data processing instructions 174. As another example, the instructions may be “Explain in a single sentence the type of data that would be generated by the following SQL statement.” Many other instructions or variations of the instructions can be used, and the computer system 110 can be configured to store or generate appropriate instructions statements.

In stage (J), the AI/ML service provider 130 generates interpretation content 192 in response to the third request 190 using an AI/ML model 132 and sends the interpretation content 192 to the computer system 110 over the network 102. For example, as indicated in the request 192, the AI/ML service provider 130 uses an AI/ML model 132 to generate natural language text that expresses the criteria and/or operations in the code or instructions 173 (and/or the data processing instructions 174). In the example, the interpretation content 192 is a statement “Sales regions ranked by profit in 2023, in descending order.”

Responding to the third request 190 can cause the AI/ML model 132 to interpret, at least in part, the code or instructions 173 that the model 132 itself generated based on the user prompt 170. For example, after an LLM interpreted the user prompt 170 and translated its criteria to SQL in response to the first request 172, responding to the third request 190 involves translating back from SQL to natural language. The interpretation content 192 shows how the prompt 170 was interpreted, described in terms of the data objects, data processing operations, and criteria used in actually generating the chatbot response 180 and any visualizations provided. If the computer system 110 has modified or enhanced the original code or instructions 173 generated by the AI/ML model 132, those changes can be provided to the AI/ML model 132, so that the data processing instructions 174 that are analyzed when generating the interpretation content 192. As a result, the interpretation content 192 can show an interpretation of a combination of the interpretation of the AI/ML model 132 as well as potential changes or other contributions of the computer system 110 to the data processing criteria. Thus, the translation from SQL back to natural language is done using a SQL statement or other code or instructions that define or describe the criteria and/or operations used to generate the results 176.

The natural language text in the interpretation content 192 can include a complete set of the criteria processed to determine the results 176. The concise statement is not required to mention every logical object or every column of data used in generating the results 176, and so may omit references to items such as table names, join operations, or intermediate results or calculations. Nevertheless, the concise statement can identify the final type of data generated (e.g., profit for sales regions) and criteria such as filters applied, sorting criteria used, and so on. In some implementations, the concise statement in the interpretation content 192 is a complete description of the criteria used to specify what the results 176 represent, so that copying and pasting the natural language concise statement of the data processing criteria to the chatbot allows the data retrieval and calculations to be re-run, allowing the user to refresh the results at a later time.

In some implementations, the computer system 110 can determine the interpretations that are involved in the code or instructions 173 and/or the data processing instructions 174, in addition to or instead of relying on an AI/ML model 132 to generate the interpretations. For example, the computer system 110 can analyze the code or instructions 173 and/or the data processing instructions 174 to identify the logical objects referenced, such as a region identifier attribute and a profit metric. The computer system 110 can use a semantic graph, pattern analysis, or other functionality to identify how these logical objects correspond to terms or phrases in the prompt 170. For example, the computer system 110 can determine that the region identifier attribute corresponds to the term “regions” in the prompt 170 and that the profit metric corresponds to the term “profit” in the prompt. The computer system 110 can generate additional interpretation content 196, such as a list of logical objects from the data set 122a involved in answering the user prompt 170. The computer system 110 can provide the identified logical objects to the user, along with additional information about them, such as the equations or expressions used to calculate metrics (e.g., profit calculated as the value of a revenue object minus a costs object).

In stage (K), the computer system 110 generates response data 182 and provides the response data 182 over the network 102 to the user device 106 as the response of the chatbot. For example, the response data 182 can include the text of the chatbot response 180 and visualization data for a data visualization 198. The response data 182 can also include information that describes the interpretations used, such as (1) (the interpretation content 192 providing a concise natural language description of the data processing performed or the type of results 176 relied on and/or (2) interpretation content 196 that indicates a list of data objects from a data set used to generate the results 176, potentially with a description or definition of calculations used to generate those data objects.

In stage (L), the user device 106 receives the response data 182 and displays the response data 182 in the user interface 162. For example, the user device 106 presents the chatbot response 180 and the visualization 198 of the results 176. The user device 106 also presents the interpretation content 192 that summarizes or describes the data processing criteria used. The user device 106 can also present the interpretation content 196 that indicates the logical objects derived from the data set 122a, along with potentially equations, expressions, or operations that show how one or more of the logical objects was calculated, especially for metrics that do not exist natively in the relevant source data set 122a used.

Because the user interface 162 shows the interpretation content 192, 196, the user 105 can quickly see if the chatbot is providing a response that correctly interprets the user's prompt 170. The interpretation content 192, 196 provides the user 105 insight and access to the internal data processing criteria used in generating the chatbot's response, allowing the user to quickly see if the interpretation varies from what the user 105 intended. This includes potentially showing the actual algorithm or equation that the AI/ML model 132 specified, through SQL or other code or instructions 173, to be used for calculating results. In addition, the interpretation content 192, 196 can reference the logical objects (e.g., metrics, attributes, etc.) of the source data set 122a, which shows the specific types of data the chatbot relied on and can give the user 105 confidence about the quality of the response. Similarly, the same interpretation content 192, 196 can reveal errors, such as in the case that the data sets used do not provide the needed data and the user's prompt 170 is mapped to incorrect logical objects that do not align with the intended meaning of the prompt 170.

The computer system 110 can use information derived from the data processing instructions 174 to generate visualizations, such as the visualization 198. Interpretations can be presented for visualizations, in the same manner as for chatbot answers. Similarly, the same type of interpretation content 192, 196 can be determined from a visualization specification that specifies characteristics of a visualization and/or data processing criteria for obtaining the data to be presented in a visualization.

In some implementations, the computer system 110 examines the data processing instructions 174 (and/or the code or instructions 173) to determine characteristics of a visualization to be created. For example, the computer system 110 can examine the data processing instructions 174 to identify data objects, relationships, and other aspects that can be mapped to features of a visualization. The computer system 110 can specify the characteristics of the visualization in a visualization specification 175, which can indicate any of various features to be shown (e.g., data objects to be retrieved or calculated, visualization type, which data series to be illustrated, independent or dependent variables, data ranges, labels for visualization components, and so on).

In some implementations, the visualization specification 175 includes sufficient information for a data processing system, such as the database system 120, to retrieve and calculate all of the data needed to create a visualization or to refresh the visualization with updated information from the data set 122a. In some cases this includes indicating when new logical objects or new quantities need to be defined. For example, if a visualization would use a new column of data that is not natively stored in the data set 122a but is calculated based on columns of data in the data set 122a, the visualization specification 175 can define this column and specify the operations or expressions used to calculated it. For example, if a visualization involves a “profit” metric not stored in the data set 122a, the visualization specification 175 can define the “profit” value to be a “sales” value minus a “cost” value, where the “sales” and “cost” are values (e.g., attributes or metrics) that are part of the data set 122a. As a result, using the visualization specification 175, the database system 120 would be able to identify the types of data that need to be retrieved and/or calculated and generate those values for the visualization.

For example, the computer system 110 can examine a SQL statement to identify data that is retrieved or calculated. The significance of the different types of data referenced can be inferred from the clauses, commands, or operators used in the SQL statement. Based on the information extracted, and the data model 149 describing the semantic meanings, data types, and/or relationships of these data objects in the data set 122a, the computer system 110 can select a visualization type, e.g., line graph, bar chart, pie chart, heat map, geographical map, etc. The selection can be based on any of multiple factors, including the number of attributes and metrics referred to (e.g., where some visualization types are better suited for larger numbers of data objects), the number of data series (e.g., line charts can show multiple data series, while a pic chart is better suited for a single group of values), relationships of the data objects (e.g., with line charts and bar charts showing relationships with respect to time better than geographical maps, which show relationships with respect to locations), the semantic meanings of the data objects (e.g., a geographical map being more likely when a city, state, country, or other geographical independent variable is present), and so on.

The visualization specification 175 can also specify other properties that may be selected based on factors or sources other than the content of the data processing instructions 174 or code or instructions 173. For example, the computer system 110 can store templates that specify visual properties for layout, formatting, font, size, color, and so on. The style template or visual style used can be selected based on user preferences, a selection for the company or other organization, a style of the current document or project in the user interface 162, a default style, and so on. These visual properties can be included in the visualization specification 175 or the visualization specification 175 can include an identifier or reference (e.g., URL) to a source of style information (e.g., a style template document, a cascading style sheet, etc.).

In some implementations, the computer system 110 can determine the type of user that is present, and vary the level of interpretation information accordingly. In some implementations, the computer system 110 determines a user type classification or determines the type of interpretation to provide based on access privileges of the user for the current document being viewed, for the current data set being accessed or manipulated, or for the AI/ML chatbot being accessed. For example, the computer system 110 can provide average users (e.g., business users of a database system) a natural language statement (e.g., the interpretation content 192) describing the interpretation the query by the AI/ML model along with the response from the AI/ML model. The computer system 110 can provide other users with higher access privileges (e.g., power users, administrators, data architects, etc.) the natural language text statement describing the interpretation as well as the interpretation content 196, e.g., an identification of logical data objects (e.g., attributes, metrics, facts, etc. that represent or are derived from data sets, tables, columns, rows, fields, etc.) and other objects (e.g., applications, objects, documents, etc.) used by or referenced by the AI/ML model in determining the response to the user prompt. These users can also be provided a user interface control (e.g., a button, icon, etc.) that users can access to obtain a copy of a SQL statement generated by the AI/ML model 132 (e.g., the code or instructions 173) or the data processing instructions 174.

For average users or business users, the system can use a standard template for providing interpretations of user prompts. For example, the system can begin with “Interpreted as:” followed by a concise, rephrased version of the user's question that explicitly states the filter criteria used for analysis, such as the time frame, and any sorting applied. If the question was asked with a specific visualization in context (e.g., as part of the user prompt, current task or document view, or conversation history), the system can reference that visualization specifically by name, by adding “based on [visualization name]” to the text of the interpretation statement.

As an example, a user prompt may be, “Can you show me the best-selling products?” To provide the AI/ML interpretation, the system can provide an along with the chatbot response such as, “Interpreted as: Displaying top 10 products by total sales volume for the current year.”

As another example, a user prompt may be, “Who are the top five performing employees in the last two years?” To provide the AI/ML interpretation, the system can provide an along with the chatbot response such as, “Interpreted as: Top five employees ranked by performance score for the years 2021 and 2022, sorted in descending order.”

In some implementations, the rephrased version of the user's question and/or the data processing criteria (e.g., for selection, aggregation, sorting, filtering, etc.) can reference data elements from one or more relevant data sets, such as a data set being represented in a current document the user is viewing or a data set associated with the chatbot. For example, the user prompt can be processed by the AI/ML model with a data model or data schema for the relevant data set(s) in the context of the AI/ML model, so that the chatbot responses, including any SQL generated or natural language text generated, can refer to the actual logical data elements available from that data set.

For a more detailed description of the interpretations used, the system can generate and provide additional items. As an example, a source of information that sets or limits a scope of data being considered can be indicated, such as identifying a particular visualization in context, a document page or section filter setting, or an “in-canvas” selection indicating one or more data sets and/or subsets of the data sets being examined. The interpretation information can show analysis steps applied, such as forecast analysis, trend analysis, key driver analysis, and so on. The interpretation information can also indicate the logical objects used, such as attributes, metrics, derived attributes, derived metrics, filter expressions, sorting expressions, and so on. The content can also include the formula expression for derived metrics, e.g., types of data that are not natively available from a data set but are calculated from the data in the data set.

When a multi-pass SQL statement is involved, the system can provide a detailed breakdown of the steps involved in creating the visualization. This will include the specific attributes, metrics, derived elements, and other components used in each step of the process, along with the intermediate results that lead to the final answer.

In some implementations, an interpretation region 194 portion of the interface 162, which includes interpretation content 192 and/or 196, is collapsed and hidden from view on initial presentation, until the user 105 selects to view the interpretation region 194 by clicking a particular interpretation icon, ensuring a clean and uncluttered interface and conserving limited screen area for the chatbot answer the user 105 requested.

A “copy to query” navigation icon can be included adjacent to the interpretation text, allowing users to easily paste the interpreted question back into the chat for further queries or adjustments.

The feature can be configured to provide the ‘Interpreted as’ explanation alongside every successful answer, e.g., answer where a substantive response to the user query 170 is provided. In cases where the chatbot delivers an error or fails to provide an answer, the option to view the interpretation may be hidden and inaccessible.

When a user asks a question while selecting a specific visualization in context, the interpretation can clarify that the provided answer is based on the data from that particular visualization.

If a user utilizes an in-canvas selector control to select particular objects or data, and the computer system 110 or the chatbot takes this into account when responding, the interpretation can acknowledge the selector's influence to offer a clearer context for understanding and problem-solving.

In general, generating and providing the interpretation information offers a transparency that assists users who value understanding AI processes. The system enhances transparency and trust by demystifying the AI's processing. In an industry where black-box solutions are common, offering transparency can significantly differentiate the system from others, benefitting users who prioritize understanding how their data is being analyzed and interpreted. The interpretation information not only provides an answer but also educates the user on the logical steps taken to reach that conclusion. This educational aspect can enhance the user experience, and helping users learn and develop their analytical skills. By revealing the steps taken to interpret and answer questions, users gain a clearer understanding of how to structure queries effectively and interpret results, speeding up the learning curve and enhancing overall user experience. If a user receives an unexpected answer to their query and gives a thumbs down, the interpretation information allows both the user and the system administrators to see the exact steps the AI took to interpret and answer the question. This transparency helps in quickly identifying where misunderstandings or inaccuracies occurred, enabling swift corrections and improvements to the AI's processing logic.

The interpretation feature also enhances enhanced transparency for sensitive or critical data analysis. For example, in industries like healthcare or finance where decisions based on data can have significant consequences, users need to fully understand how conclusions are drawn. The system provides the necessary transparency and detailed explanation, ensuring that users are fully informed about the basis of the AI's conclusions, thus supporting responsible and informed decision-making. In addition, the interpretation information facilitates continual improvement and overall learning of the system in a feedback loop. Over time, users might find certain patterns of queries consistently yield less satisfactory results. Generating and providing interpretation information allows for a direct feedback loop, where users can flag issues with specific interpretations or execution steps. Analysts and developers can then use this targeted feedback to refine algorithms, improve natural language processing capabilities, and enhance the overall accuracy and effectiveness of the AI system.

For business users, the system can present AI's understanding of user questions affirmatively and clearly. The output can include references to specific visualizations if queries are made in that context, and can enable users to copy and paste interpretations into the chat for consistent results. For power users, the system can identify detailed visualization components and SQL generated by the LLM. Interfaces can include a discrete icon for copying LLM-generated SQL, aiding in validation and troubleshooting. For multi-pass SQL, show a step-by-step breakdown of visualization creation can be provided.

In some implementations, the interpretation statement can be a natural language text narrative describing or summarizing the interpretation. This interpretation statement can be generated by asking one or more AI/ML models 132 to generate a text description (e.g., a summary, overview, explanation, etc.) of the function of the generated code or instructions or of the interpretations made in the generated code or instructions. Information from a data model or data schema also enables the AI/ML models 132 to accurately describe the interpretations with natural language terms that the user can understand and recognize from the data set. The natural language description can describe each step of multiple steps of data processing, in addition to or instead of describing the process as a whole.

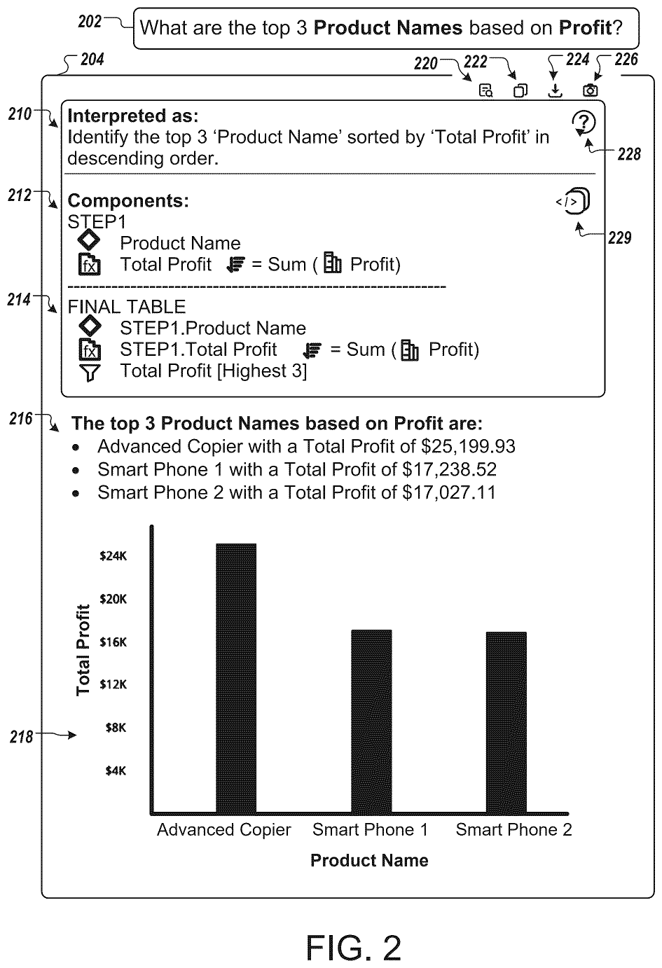

FIG. 2 shows another example of a chat interface, where a user prompt 202 leads to a chatbot response and interpretation information that describes how the user prompt 202 was interpreted and how data was processed to arrive at the response.

In the example, the user prompt 202 is the question, “What are the top three product names based on profit?” In the interface, the system has identified the terms “product names” and “profit” in the prompt 202 as representing data objects that are either included in, or can be derived from, one or more data sets, e.g., one or more data sets relevant to a current conversation, current task, current document, or the chatbot itself. To indicate that these terms have been mapped to data objects, the identified terms with identified data objects can be visually distinguished in the user interface, through differences such as color, size, highlighting, underlining, and so on. The computer system 110 can identify these terms as corresponding to particular data objects in one of various ways, such as through the interpretation content discussed further below. As another example, the computer system 110 can identify relevant data objects for terms based on a semantic graph or other data.

The example shows a response 204, which shows the response of the chatbot to the prompt 202 as well as interpretation information.

The interpretation information includes an interpretation summary 210, which is a natural language statement that provides a concise description of the data processing (e.g., data retrieval and/or calculation) performed to answer the user's prompt 202. The interpretation summary can represent an interpretation or restatement of the user prompt 202. In particular, the interpretation statement 210 includes the criteria derived from the prompt 202, such as criteria interpreted as being specified by the prompt 202 or needed to answer the prompt 202. This can include criteria for retrieving and processing data (e.g., aggregating, sorting, filtering, etc.).

In addition, or as an alternative, the interpretation summary 210 can represent a summary or restatement of the data processing operations performed to retrieve and generate data presented in the chatbot's response (e.g., response text 216 and visualization 216). For example, the interpretation summary 210 can include or be based on natural language text generated by the AI/ML model 132. The interpretation summary 210 can be text generated by the AI/ML model 132 in response to a request for the AI/ML model 132 to summarize or state in natural language the operations or criteria specified in a set of code or instructions.

For example, the computer system 110 can provide a set of code or instructions used by the database system 120 to generate the data or the results used to provide the chatbot response text 216 and visualization 218. The AI/ML model 132 may be used to generate code or instructions based on the user prompt 202, and then the code or instructions (or a modified version of them) can be provided back to the AI/ML model 132 with a request to summarize the operations called for. For example, the AI/ML model 132 can be used to translate from a set of data processing instructions, such as a SQL statement, to a natural language summary. Depending on the implementation, other techniques can be used. For example, the interpretation summary 210 can be generated by asking the AI/ML model 132 to summarize or restate the user prompt 202 itself.

The response 204 includes additional areas that further identify the logical data objects accessed or calculated when generating the database results used to answer the prompt 202. For example, the data retrieval and data processing for answering the user prompt 202 involves two steps, and so a description of each step is shown separately in the interpretation panel. A first section 212 shows components of a first step or first stage of processing. The section 212 identifies various data objects as components of the data set used in generating the chatbot response. For example, the first step is identified as involving a table STEP1 that was generated as intermediate data before reaching the final results. The table STEP1 has an attribute labeled “Product name” and a metric named “total profit” which are both derived from the source data set. The section 212 also defines the metric “total profit” with an expression that specifies the operation used to generate values of total profit. For example, the section 212 indicates that total profit is the result of summing a set of values of a “profit” quantity, which can represent a fact or data item in the source data set.

Region 214 shows the second step or stage of processing which results in a table labeled “FINAL TABLE.”. This table is shown having information from step one that is further processed or manipulated. For example, there is an attribute STEP1.Product Name and a metric named STEP1.Total Profit. These data objects are taken from the STEP1 table referred to in region 212. In addition, the region 214 indicates that the data is filtered to show the three products names with the highest profit. In the regions 212 and 214, icons designate whether the various data objects are metrics, attributes, facts, filter criteria, or other types of data objects.

The information in the regions 212 and 214 can be taken from the data processing instructions used to generate the results used to generate the chatbot output 216 and visualization 218. As with the interpretation summary 210, the set of data objects and relationships shown in the regions 212 and 214 can indicate the set of data objects and data processing operations on which the chatbot response below is based, as determined based on the code or instructions from an LLM or a modified version of the code or instructions from the LLM. In some implementations, if the AI/ML model 132 is used to generate a SQL statement based on the user prompt 202, if the system modifies that SQL statement, the interpretations shown in the regions 212 and 214 can be based on the modified version that was actually processed by the database system 120.

The content of the regions 212 and 214, and in particular the identification of data objects used and equations or data processing operations performed, can be generated by the computer system 110 based on the final set of data processing instructions used to retrieve data by the database system 120. In other words, after a final modified or enhanced SQL statement is ready, the computer system 110 can identify the logical data objects and their definitions from that enhanced SQL statement. Because these data elements are part of the data schema or data model for the data set, the computer system 110 can readily extract the references to these data items and also any equations or other criteria defined therein. The computer system 110 can store a set of rules or patterns or keywords that assist the computer system 110 to map phrases or patterns of syntax in SQL statements that correspond to different operators, functions, or other types of content.

The response 204 includes the chatbot response text 216 below the interpretation content. This example also shows a visualization 218 that is generated based on the results retrieved from the data set. The chatbot response text 216 can be generated by the chatbot, based on the user prompt 202 and also the results the database system 120 generated from the source data set. In some implementations, the visualization 218 can be generated by the computer system 110 based on the data processing instructions or SQL statement used, but the visualization data for the visualization 218 can be generated in a deterministic manner without using an AI/ML model. For example, as discussed above for FIG. 1, a visualization specification can specify properties of a visualization, including the data to retrieve and processing to obtain the data to be represented in the visualization 218. From that information, the computer system 110 can generate the visualization data for the visualization 218.

The response 204 can include various user interface controls that enable the user to initiate various functions. For example, a control 220 is selectable by the user to show or hide the interpretation content, e.g., the panel that includes the interpretation summary 210 and the content in regions 212, 214.

The interface can include a control 222 to copy some are all of the content in the response 204. For example, the control 222 can be provided to copy interpretation content (such as the interpretation statement 210) and/or response content (e.g., chatbot output 216 and visualization 218) to a clipboard of the user device for use or export in other applications.

The interface can include a control 229 configured to cause code or instructions used generate data for the response to be copied to a clipboard or presented for view. For example, when a user clicks or taps the control 229, the interface can cause the SQL statement that the interpretation content in 210, 212, 214 is describing, e.g., the SQL statement generated by an AI/ML model 132 in response to the prompt 202, to be copied to a clipboard. As an alternative, clicking the control 229 may cause the SQL statement to be presented in a pop-up window or opened in an editor for the user to view. In this manner, the interface provides the user a way to export or obtain the SQL statement used in responding to the prompt 202, e.g., the SQL statement generated by an LLM or used to retrieve the results used to generate the response 216 and response visualization 218.

Another control 224 allows a user to download content of the response 204. The control 226 allows the user to take a snapshot as a way of capturing the content of the response 204, such as by creating or saving a screenshot image of some or all of the response 204. In addition, or as an alternative, the control 226 can create a type of snapshot in the chatbot to save the response 204 and associated context, so the current portion of the conversation is saved and remains available for the user in future sessions, similar to bookmarking or tagging this response 204 for quick retrieval in the future.

The interface includes an additional control 228 that can be selectable by a user to copy the natural language text interpretation into the text entry field of the chat interface. For example, the control 228, when clicked or tapped by a user, can insert the interpretation summary 210 into the text entry field where the user enters prompts to the chatbot. This quickly places the data processing criteria in the text entry field, where the user can make adjustments and corrections to refine the request to the chatbot. This allows users to iteratively refine their prompts using a clear and unambiguous set of criteria.

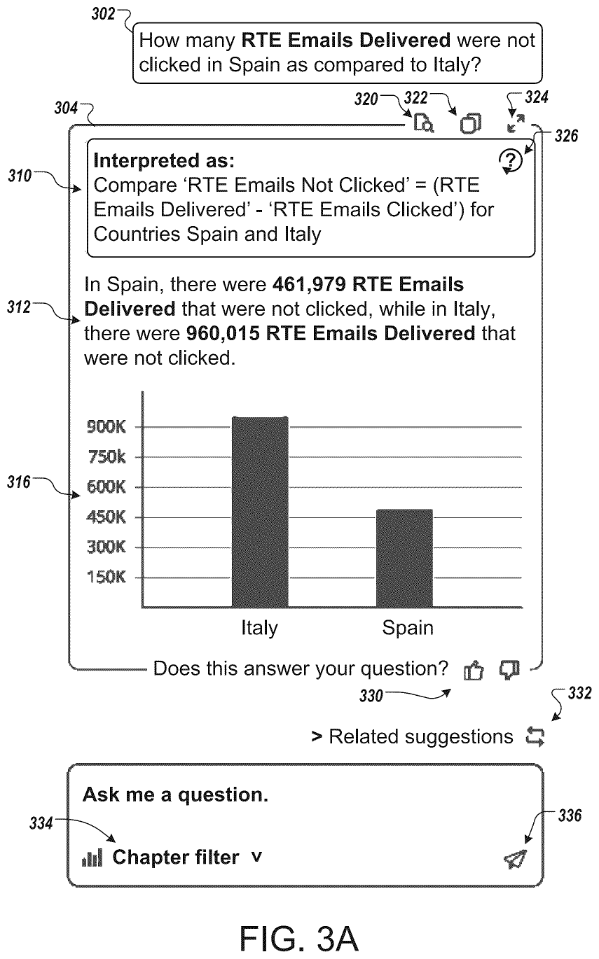

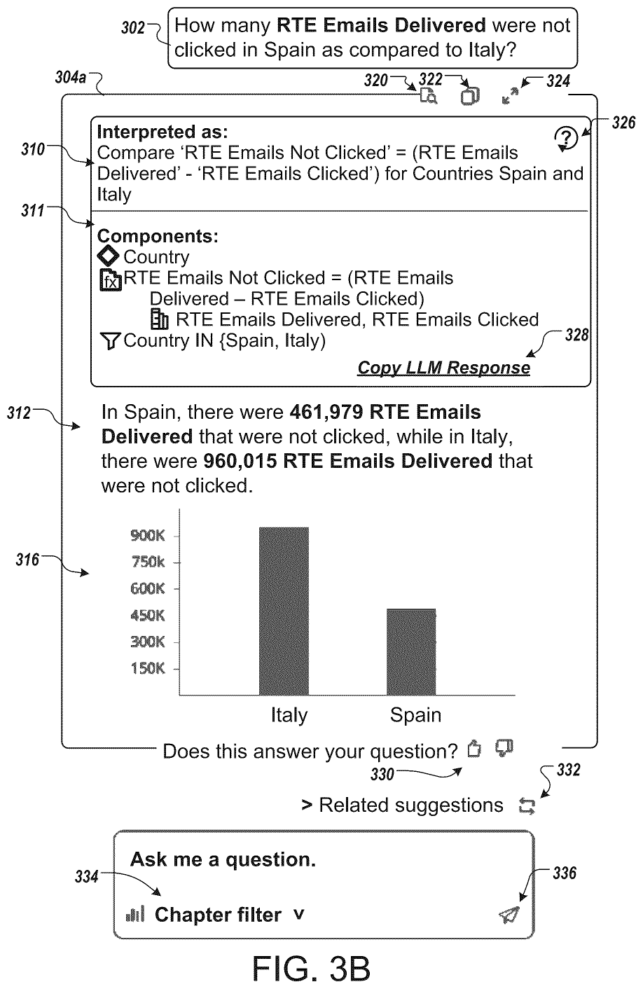

FIG. 3A is another example of a user interface of a chatbot. The interface shows a user prompt 302, “How many RTE emails delivered were not clicked in Spain as compared to Italy?” In response to the prompt 302, the chatbot provides the content in the region 304, which includes an interpretation summary 310, a text response 312 and a visualization 316.

As discussed above for FIG. 1, the process of responding to the user prompt 302 includes requesting that the AI/ML model 132 generate code or instructions, such as a SQL statement, for retrieving or generating data from a data set. The computer system 110 can then update or enhance the generated code or instructions to form data processing instructions (e.g., an enhanced or updated SQL statement) executed by the database system 120. The interpretation summary 310 is a text restatement of the data processing instructions (e.g., enhanced SQL statement) used to generate the results discussed and illustrated in the chatbot response 312, 316. For example, the interpretation summary 310 can be text that the AI/ML model 132 generated when the model 132 was asked to summarize or describe the data processing instructions used.

As another example, the interpretation summary 310 may be a text statement generated by the computer system 110 and not text generated by the AI/ML model 132. For example, the computer system 110 can analyze the data processing instructions (and/or the code or instructions that the AI/ML model 132 generated) to identify the metrics, attributes, equations, and criteria specified. The computer system 110 can then insert the data objects and criteria extracted from the data processing instructions into an interpretation template or grammar, so that the computer system 110 populates fields in the template to provide the interpretation summary 310. In the example of FIG. 3A, a brief set of information about the interpretation is provided, which is often appropriate for some classes or categories of users. Here, this includes the interpretation statement 310 without a separate list of data objects referenced.

The response area 304 includes chatbot text response 312 that the AI/ML model 132 generated using the user prompt 302 as well as the results retrieved or generated by the database system 120. The visualization 316 illustrates the same results used by the AI/ML model 132 to generate the text response 312. The visualization 316 can be a visualization generated by the computer system 110 from the results from the database system 120, rather than a visualization generated by an AI/ML model 132. As a result, the overall response from the chatbot can be a combination of content generated by an AI/ML model 132 (e.g., the response text 312) as well as content generated by the computer system 110 (e.g., the visualization 316).

The response area 304 includes a number of interactive user interface elements for interacting with the response content. For example, the interface includes a control 320 that when interacted with causes the interpretation content to be shown or hidden. Initially, the response area 304 can omit the interpretation statement, but the control 320 can be provided. The interface responds to tapping or clicking the control 320 by presenting the interpretation statement 310. Then, tapping or clicking the control 320 from the view shown in FIG. 3A may cause the interface to hide the interpretation statement 310 and other interpretation content. Once hidden, tapping or clicking the control 320 can cause the interpretation content to be displayed again.

In addition, the interface includes a control 322 to initiate copying some or all of the content in the response area 304 to a clipboard for use in other applications or interfaces. For example, the interacting with the control 322 can cause the chatbot text response 312 and the visualization 316 to be copied to the clipboard, as an image or screenshot, or as an image and text, or in another form. The interpretation content 310, if displayed, can also be included in the copied content.

The interface also includes a control 324 allowing the user to adjust the size of the view of the response area 304 or the chat interface as a whole, such as to expand the view to fill the current window, region, or screen, or later to reduce it from full size to a smaller size.

The interface also includes a control 326 that enables a user to copy the interpretation statement 310, for example, to insert a copy into the text entry field for the next prompt to the chatbot, where the user can edit, correct, or otherwise refine the set of criteria used. The control 326 can facilitate a user asking again the same question, potentially with variations the user specifies by further editing the statement.

The response area includes a set of controls 330 for a user to provide feedback about the chatbot's response. For example, the controls 330 can include a thumbs up icon and a thumbs down icon, which a user can interact with to indicate whether the response and/or interpretation are acceptable. The computer system 110 stores the user rating along with the user prompt 302 the interpretation, and the chatbot response. The feedback from users can be used to improve the accuracy and usefulness of the chatbot in the future, such as by providing an administrator information to adjust the chatbot or to automatically adjust or bias the chatbot so the computer system 110 learns automatically from user feedback.

The interface includes a control 332 that enables a user to interact in order to view suggested questions, these suggestions can be derived from the current conversation, including the context of the user prompt 302 and response content in region 304, as well as previous content in the conversation and even previous conversation sessions. The control 332 can be used to regenerate a new set of suggestions, which can be generated by the computer system. 110 based on user preferences, frequent or recent questions by the user or other users, especially for the data set or chatbot or document the user is currently using. In some implementations, the computer system 110 sends a request to an AI/ML model 132 for the model 132 to generate suggested questions.

The interface includes a filter control 334 that enables the user to select one or more sections of a document to focus or limit the content or data sets considered by the chatbot. For example, in a document with multiple chapters or sections, the user can use the control 334 to select a specific chapter or group of chapters. After setting the filter, when the user enters a prompt to the chatbot, the chatbot will use the context of those specified chapters. This can focus or limit the context considered by the chatbot to the text content, visualizations, and data sets that are referenced or discussed in those chapters.

The interface includes a control 336 that enables the user to send information from the chat conversation, such as a particular prompt 302 and response 304 or other information.

FIG. 3B shows another example interface that includes the same prompt 302 as FIG. 3A. In FIG. 3B, however, a more detailed set of interpretation content is provided. This more detailed set of interpretation content can be provided based on a user preference, an identity of the user, a level of permissions of the user (e.g., for the associated data set and/or document being viewed), etc.

In addition to the interpretation summary 310, the response 304a also includes object information 311 specifying the components of a data set that were used to respond to the user prompt 302. For example, the object information 311 can list metrics, attributes, filters, and other logical data objects that are referenced in the data processing instructions that the database system 120 executed to generate the results represented in the chatbot response text 312 and the visualization 316.

In further detail, the object information 311 indicates that an attribute “Country” from a source data set was used, and this may correspond to information in a column of a data table of the source data set. The object information 311 also specifies a metric for “RTE Emails Not Clicked” and provides a definition of how this metric is calculated. For example, it shows that the metric is determined based on two facts in the data set, the amounts of RTE emails delivered and RTE emails clicked. The metric for “RTE emails not clicked” is defined as the amount of “RTE Emails Delivered” minus the “RTE Emails Clicked.” The object information 311 also specifies filter criteria, including that the country attribute is filtered to the two values of “Spain” and “Italy.”

The interface includes an interactive control 328 that the user can interact with to copy the code or instructions used to generate the results from the database system 120. For example, a user can click the control 328 to cause the code or instructions generated by the AI/ML model 132 to be copied to the clipboard. As another example, clicking the control 328 can cause the enhanced or updated version of a SQL statement, in the form used by the database system 120, to be copied for further review or editing by the user. Typically, the code or instructions generated by the AI/ML model 132 (and/or the enhanced version of the code or instructions ultimately used by the database system 120) are not displayed to the user in the chatbot interface. However, the interface can make the code or instructions (e.g., SQL statement) available to the user, such as through the user interface element 328.

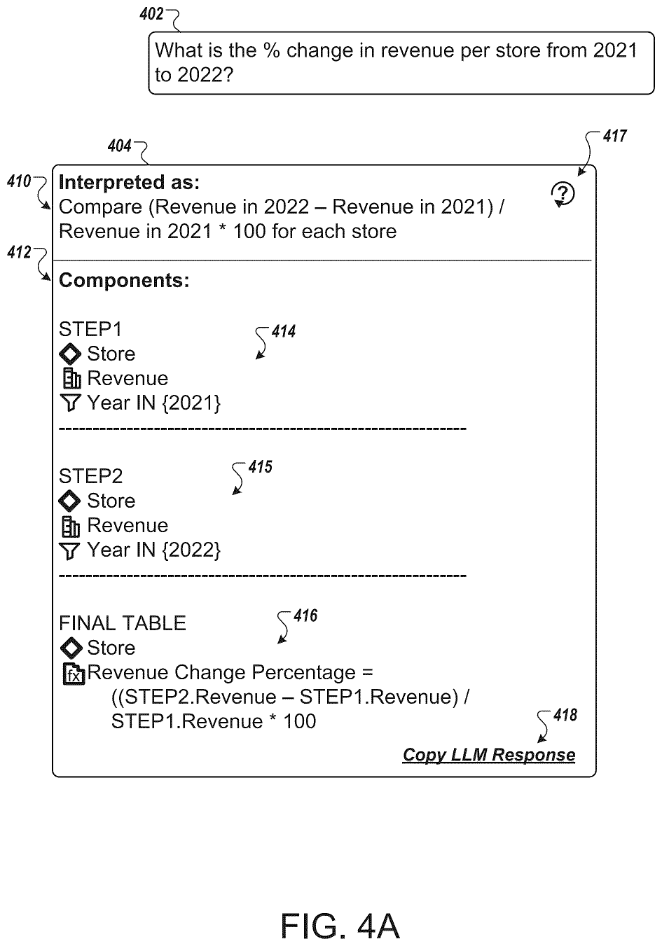

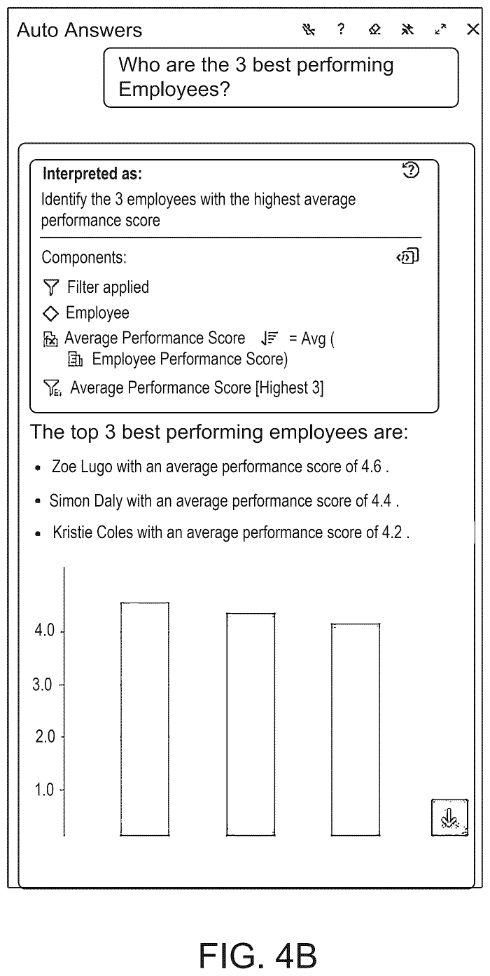

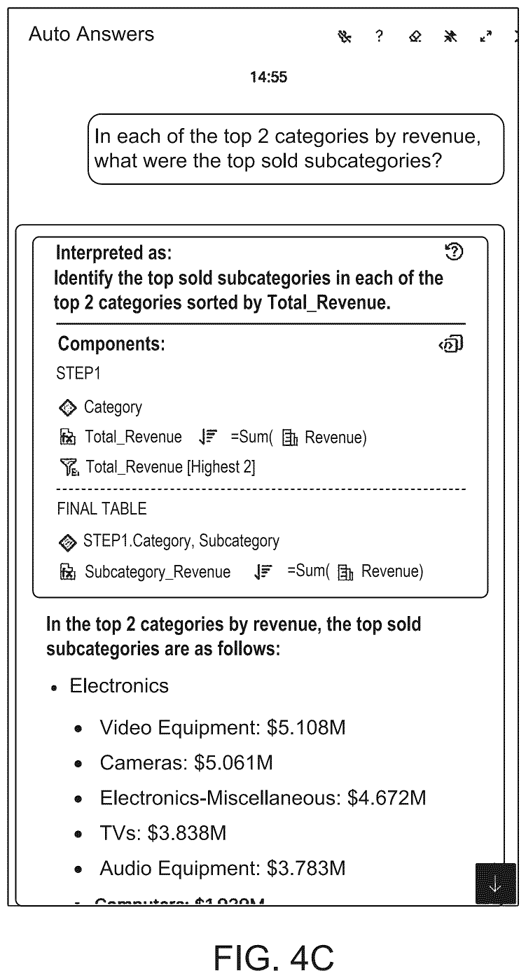

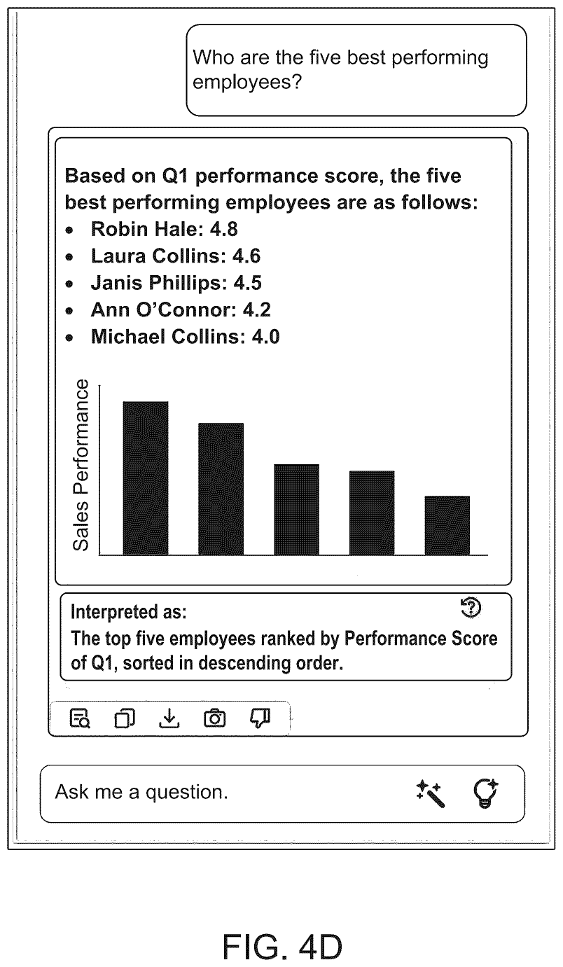

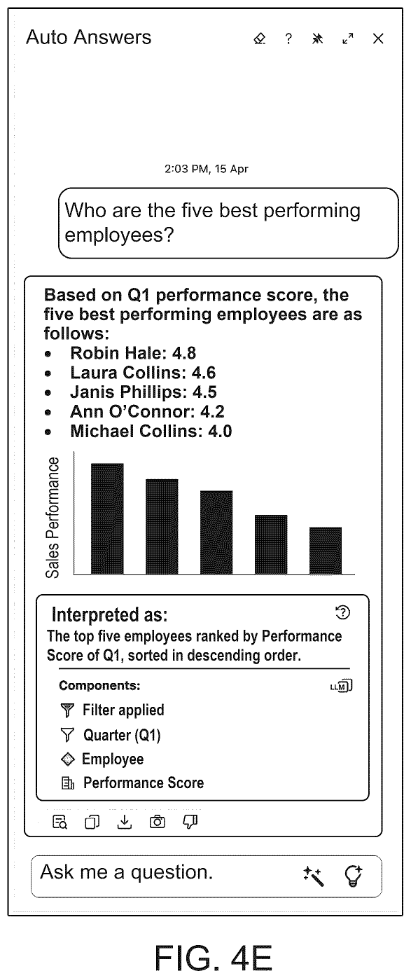

FIG. 4A shows another example of a chat user interface. The user submits a user prompt 402, “What is the percentage change in revenue per store from 2021 to 2022?” In the example, only the interpretation content is shown, and the main chatbot response is omitted.

The interpretation content 404 includes an interpretation summary 410, which illustrates in text. Logical data objects used and criteria applied, and how they relate to calculate the results that answer the user prompt 402.

The interpretation content 404 also includes a more detailed list of components 412, to indicate the attributes, metrics, filter criteria, and other items. As with other interpretations, a list of data objects used can be extracted from code or instructions generated by the AI/ML model 132 or an enhanced or updated version of the code or instructions. For example, a modified SQL statement used to generate the results for responding to the user prompt 402 can be the source analyzed to determine the list of components 412.

In this example, the SQL statement includes multiple steps, including the generation of two intermediate tables or data sets, and a final table to obtain the final result. The first step involves creating a table STEP1, which includes a “Store” attribute, a “Revenue” fact or metric, and a filter to limit data to the year 2021. The second step involves generating second intermediate table named STEP2, which includes the “Store” attribute and the “Revenue” fact or metric, filtered to the year 2022. The final step 416 involves creating a “FINAL TABLE,” which again involves the “Store” attribute, and also has a metric named “Revenue Change Percentage.” The definition of this metric is specified as an equation or expression that references data from the STEP1 table and the STEP2 table. For example, the “Revenue Change Percentage” metric is defined by the calculation of “Revenue” from STEP2 minus the value of “Revenue” from STEP2, with that quantity being divided by the revenue from STEP1 and multiplied by 100. The result will provide the change of revenue per store as requested in the user prompt 402.

The interface includes a user interface control 417 that, when interacted with by a user, copies the interpretation summary 410 into the chatbot input field so the user can ask again the same question, or so the user can add context or edit the question. For example, the user may determine that the AI/ML model 132 used a different data object or a different filter setting than the user intended. The user can interact with the control 417 to insert the interpretation summary 410 into the chatbot interface as a new prompt, and the user can correct the error or specify additional context that would allow the AI/ML model 132 to improve the result in the next response. In some implementations, a control can be provided to copy the interpretation summary 410 to a clipboard to the clipboard for use in other interfaces or applications.

The user interface also includes a user interface control 418 that, when interacted with by a user, copies the SQL statement or other code or instructions used. For example, when a user clicks the control 418, code or instructions generated by the AI/ML model 132, or the enhanced or updated version processed by the database system 120, is copied to the clipboard.

FIG. 4B-4E show additional examples of chat user interfaces showing prompts, chatbot responses, and interpretation content generated for the user. The interpretations help users understand how AI processes and understands queries, to provide clarity and confidence in every result. This allows on-the-fly refinement, so users can refine questions in real-time, ensuring responses are optimized for the most relevant insights. It also allows advanced testing and troubleshooting, so power users can see detailed execution pathways, including specific data objects or data set components used, enabling advanced diagnostic capabilities.

For power users, when a multi-pass SQL statement is involved, the interpretation content can provide a detailed breakdown of the steps involved in creating the visualization. This can include the specific attributes, metrics, derived elements, and other components used in each step of the process, along with the intermediate results that lead to the final answer.

In some implementations, the interpretation region remains collapsed or hidden until a user chooses to view it by clicking the interpretation icon, ensuring a clean and uncluttered interface. A “copy to query” navigation icon can be included adjacent to the interpretation text, allowing users to easily paste the interpreted question back into the chat for further queries or adjustments. The interpretation feature can ensure that the ‘Interpreted as’ explanation appears alongside each successful answer. In cases where the chatbot delivers an error or fails to provide an answer, the option to view the interpretation can be hidden and inaccessible.

When a user asks a question while selecting a specific visualization in context, the interpretation can clarify that the provided answer is based on the data from that particular visualization. If a user utilizes an in-canvas selector (e.g., to select a visualization or region of a document) and the chatbot takes this into account when responding, the interpretation can acknowledge the selector's influence to offer a clearer context for understanding and problem-solving. The interpretation content can also include the formula expression for derived metric.

The interpretation content can be saved as part of a snapshot, with an option to copy the interpretation to the chat. The interpretation and execution steps for a specific question can be accessible only during the session in which the question was asked, unless it was saved to snapshots. This means that when a user ends their session with the chatbot and later returns to continue the chat, the interpretation icon won't appear for answers from the previous session.

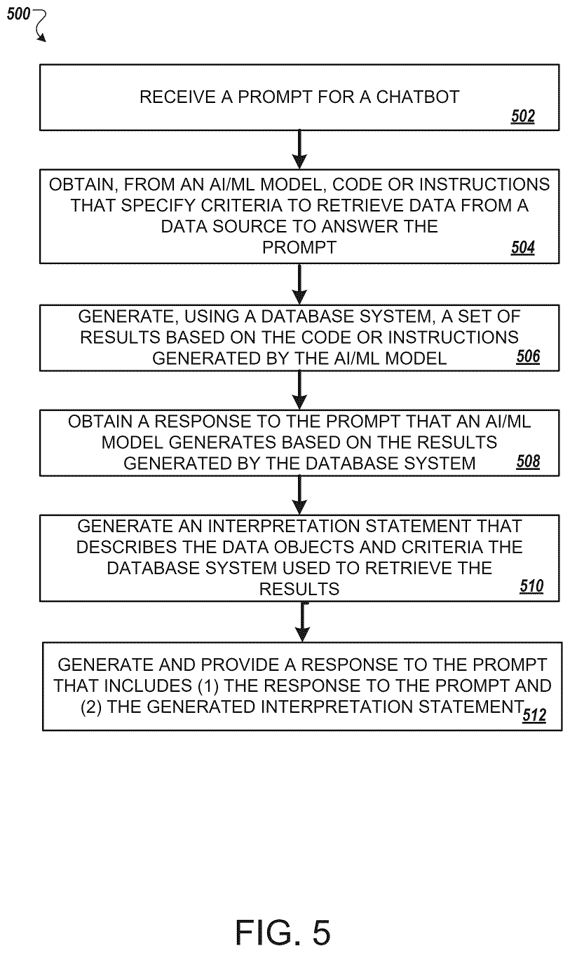

FIG. 5 shows an example of a process 500 for determining and revealing interpretations of artificial intelligence models. The process 500 can be performed by one or more computers, such as the computer system 110, as well as other systems such as the database system 120 and the AI/ML service provider 130.

The process 500 includes receiving a prompt for a chatbot (502). For example, a user can enter a text prompt in a chat interface of a chatbot.

The process 500 includes obtaining, from an AI/ML model, code or instructions that specify criteria to retrieve data from a data source to answer the prompt (504). For example, the computer system 110 can generate a request that includes text from the prompt and a data model or data schema that specifies data items that are available in one or more data sets. This request can request code or instructions, such as a SQL statement, that would retrieve and/or generate data that is needed to answer the user's original question.

The process 500 includes generating, using a database system, a set of results based on the code or instructions generated by the AI/ML model (506). For example, the computer system 110 can use the code or instructions from the AI/ML model to generate a request or command to the database system. This may include modifying or enhancing the code or instructions from the AI/ML model to better align with the properties of the data set involves or the characteristics of the database system. For example, code or instructions received from the AI/ML model can be enhanced to improve efficiency and compatibility. The database system 120 then executes the received data processing instructions and provides results, such as a set of values or a table of data.

The process 500 includes obtaining a response to the prompt that an AI/ML model generates based on the results generated by the database system (508). For example, after receiving the results from database system 120, the computer system 110 can send a second request to the AI/ML model 132 requesting an answer to the prompt, and providing context of the prompt, the data model or data schema for the data set, and the results generated by the database system. As a result, the AI/ML model can generate a response to the prompt that is based on the results retrieved and/or generated from the original source data set by the database system 120.

The process 500 includes generating an interpretation statement that describes the data, objects and criteria the database system used to retrieve the results (510). For example, the computer system 110 can use the AI/ML model 132 to generate a statement of the data objects used and operations applied. For example, the computer system 110 can provide the code or instructions used by the database system 120, such as an SQL statement, and request that the AI/ML model 132 provide a concise statement of the meaning of the code or instructions. In addition, or as an alternative, the computer system 110 can analyze the code or instructions used by the database system 120 to generate the results, and the computer system 110 can identify the logical data, objects and operations or criteria specified. The interpretation statement can then include a list or description of the logical data, objects and operations and criteria applied.

The process 500 includes generating and providing a response to the prompt, where the a response includes (1) The response to the prompt and (2) the generated interpretation statement (512). For example, computer system 110 can provide the response generated by the AI/ML model, for presentation in a chat interface. The interpretation statement can be provided for display alongside the response from the chatbot. In some implementations, interpretation statement or a portion of it may be initially hidden, but user interface element such as a button or icon can be provided that, when interacted with by a user, causes the interpretation statement to be displayed or expanded for view.

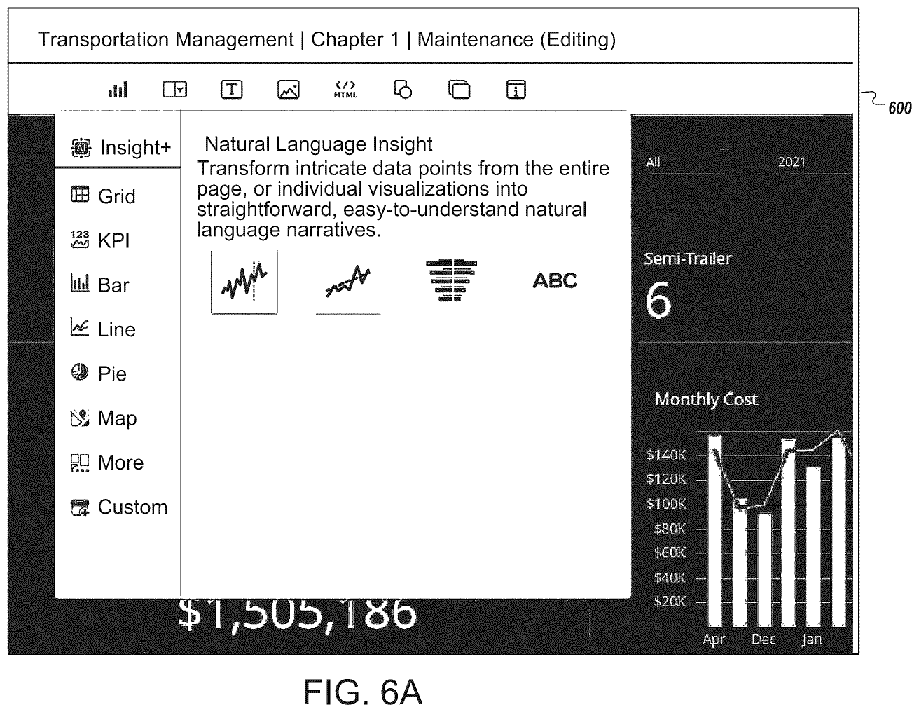

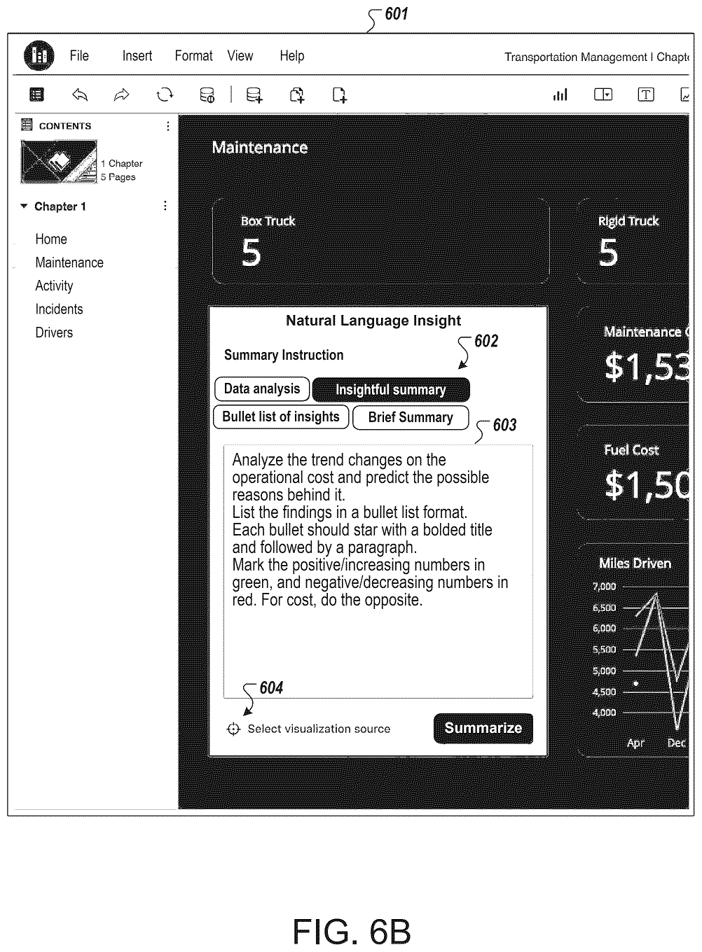

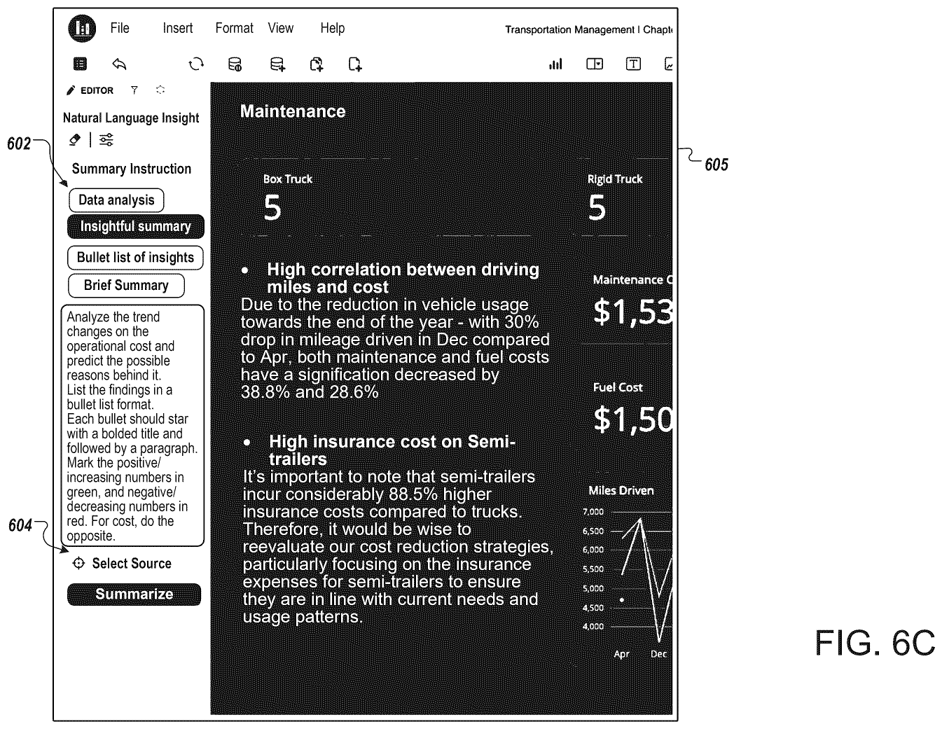

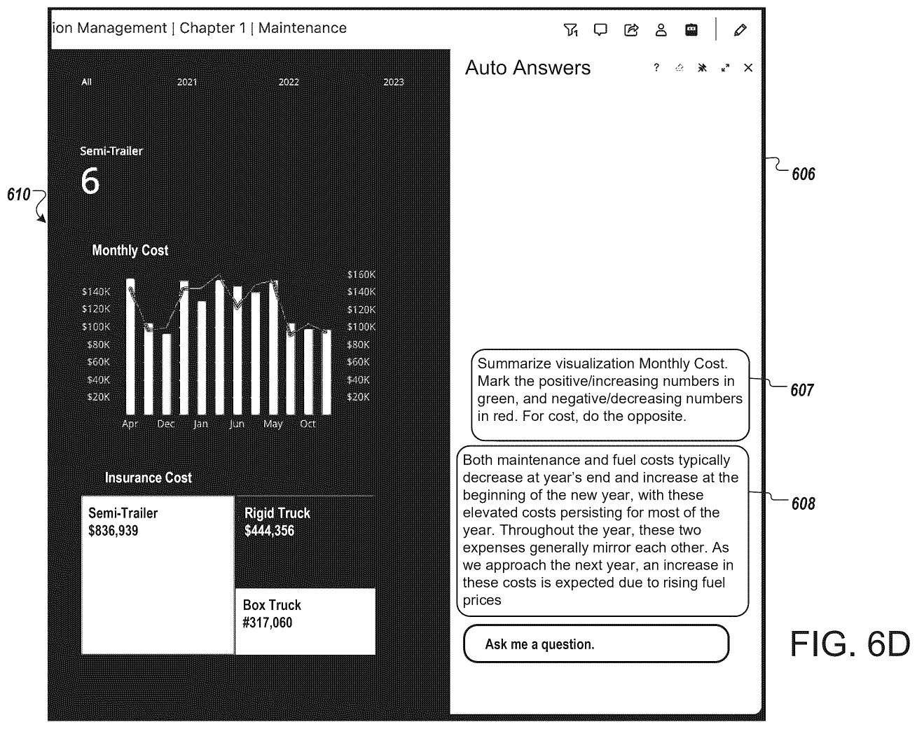

FIGS. 6A-6D show example user interfaces showing functionality for showing natural language insight derived from visualization data and other content.

FIG. 6A shows an example how the system can provide a user an interface to obtain natural language summaries or insights from other content, whether the content was generated with an AI/ML model or generated in another form. The functionality can use an LLM or other model to convert complex dashboard data into clear, natural language narratives. The information is generated based on the current context, e.g., the current page or view of a document being viewed or edited, or the context of a chatbot conversation. The system can tailor narratives to the viewer's role and context, ensuring they see the most relevant insights for their decisions. When generating the natural language information, the source material can vary according to the user's needs, to create narratives from an entire dashboard, a specific page, or selected visualizations.

FIG. 6B shows another example user interface 601 that shows how the natural language narratives or insights can be created. The user interface 601 shows multiple different types of natural language content that can be generated, such as data analysis, insightful summary, bullet list of insights, or brief summary. For each of these options, the system stores a predetermined instruction to an AI/ML model 132. Each of these options is represented as a interactive user interface element 602, and when the user selects one of the UI elements 602, the text field 603 below is populated with the instruction to be provided to the AI/ML model 132. This provides the user the ability to see and potentially edit what will be requested, and how the different types of summaries differ from each other. The user interface 601 also includes a control 604 to select a visualization source, so the user can specify specific data to be summarized, such as a specific visualization, a page of a document, a dashboard, and so on.

FIG. 6C shows another example user interface 605 that provides the UI elements 602 representing different types of summary instructions that populate the text field 603 to be viewed. The user has selected the Insightful Summary option, which includes an instruction, “Analyze the trend changes on the operational cost and predict the possible reasons behind it. List the findings in a bullet list format. Each bullet should start with a bolded title followed by a paragraph. Mark the positive slash increasing numbers in green, and negative slash decreasing numbers in red. For cost, do the opposite.” In response, the system has provided the summary in the area to the right, with a bullet list format and color coding of metric values as requested. The data being summarized is taken from the current document, such as the data being visualized in one or more visualizations.

FIG. 6D shows an example user interface 606 of a summary response showing a natural language summary 608 of the visualization 610 in a document. The user selected the visualization titled “Monthly Cost,” and selected the “Brief Summary” option. This provided an instruction, “summarize visualization monthly cost. Mark the positive/increasing numbers in green and negative/decreasing numbers in red. For cost, so the opposite.” The computer system 110 sends the instruction, along with the visualization data (e.g., table of data being visualized, visualization specification, data model or data schema for the related data set(s), etc.) to the AI/ML model 132 to be processed. The system 110 provides the response 608 generated by the AI/ML model 132, “both maintenance and fuel costs typically decrease at year's end and increase at the beginning of the new year, with these elevated costs persisting for most of the year. Throughout the year, these two expenses generally mirror each other period as we approach the next year, an increase in these costs is expected due to rising fuel prices.” Although an LLM typically you cannot read visual data or image content, the computer system 110 provides the LLM the data series for results that are represented in the visualization, Along with the metadata, semantic information, data model, and other context needed to interpret the values provided. As a result, the AI/ML model is able to provide summary natural language information according to the instruction, based on existing data sets and visualizations.

A number of implementations have been described. Nevertheless, it will be understood that various modifications may be made without departing from the spirit and scope of the disclosure. For example, various forms of the flows shown above may be used, with steps re-ordered, added, or removed.

Embodiments of the invention and all of the functional operations described in this specification can be implemented in digital electronic circuitry, or in computer software, firmware, or hardware, including the structures disclosed in this specification and their structural equivalents, or in combinations of one or more of them. Embodiments of the invention can be implemented as one or more computer program products, e.g., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Particular embodiments of the invention have been described. Other embodiments are within the scope of the following claims. For example, the steps recited in the claims can be performed in a different order and still achieve desirable results.

1. A method performed by one or more computers, the method comprising:
receiving, by the one or more computers, a prompt from a user;
obtaining, by the one or more computers, code or instructions generated by one or more artificial intelligence or machine learning (AI/ML) models, wherein the code or instructions specify criteria to retrieve data from a data source to respond to the prompt;
generating, by the one or more computers, a set of results from the data source based on the generated code or instructions;
obtaining, by the one or more computers, a response to the prompt that the one or more AI/ML models generate using at least a portion of the set of results;
generating, by the one or more computers, an interpretation statement that indicates how the prompt was interpreted by the one or more AI/ML models; and
providing, by the one or more computers, output that includes (i) the response to the prompt and (ii) the generated interpretation statement.

2. The method of claim 1, wherein the one or more AI/ML models comprise a large language model (LLM).

3. The method of claim 1, wherein the interpretation statement comprises a summary or description of information that the code or instructions are configured to obtain from the data source.

4. The method of claim 1, wherein the interpretation statement indicates data objects or criteria used to retrieve the set of results.

5. The method of claim 1, wherein the interpretation statement indicates at least one of (i) a mapping between one or more terms of the prompt to one or more corresponding data objects, wherein the mapping was determined by the one or more AI/ML models, or (ii) one or more formulas or equations that indicate how a portions of the set of results was calculated.

6. The method of claim 1, wherein providing the output comprises providing output that causes a particular term of the prompt to be annotated or visual distinguished from other terms in the prompt; and
wherein the interpretation statement designates an attribute, metric, or other data object that is interpreted to represent the particular term.

7. The method of claim 1, wherein the code or instructions comprise a structured query language (SQL) statement.

8. The method of claim 1, wherein the code or instructions comprise executable or interpretable code.

9. The method of claim 1, wherein the code or instructions include data filtering parameters or data aggregation parameters for generating the set of results; and
wherein the interpretation statement indicates the data filtering parameters or data aggregation parameters.

10. The method of claim 1, wherein obtaining the code or instructions comprises providing, to the one or more AI/ML models, a data model or data schema for one or more data sources, wherein the code or instructions include references to data objects in the data model or data schema; and
wherein the interpretation statement includes references to the data objects in the data model or data schema.

11. The method of claim 1, wherein the interpretation statement is generated by analyzing the code or instructions together with a data model or data schema for the data source.

12. The method of claim 1, wherein the interpretation statement comprises text generated by the one or more AI/ML models in response to a request to summarize or explain interpretations used in the generated code or instructions.

13. A system comprising:
one or more computers; and
one or more computer-readable media storing instructions that are operable, when executed by the one or more computers, to cause the system to perform operations comprising:
receiving, by the one or more computers, a prompt from a user;
obtaining, by the one or more computers, code or instructions generated by one or more artificial intelligence or machine learning (AI/ML) models, wherein the code or instructions specify criteria to retrieve data from a data source to respond to the prompt;
generating, by the one or more computers, a set of results from the data source based on the generated code or instructions;
obtaining, by the one or more computers, a response to the prompt that the one or more AI/ML models generate using at least a portion of the set of results;
generating, by the one or more computers, an interpretation statement that indicates how the prompt was interpreted by the one or more AI/ML models; and
providing, by the one or more computers, output that includes (i) the response to the prompt and (ii) the generated interpretation statement.

14. The system of claim 13, wherein the one or more AI/ML models comprise a large language model (LLM).

15. The system of claim 13, wherein the interpretation statement comprises a summary or description of information that the code or instructions are configured to obtain from the data source.

16. The system of claim 13, wherein the interpretation statement indicates data objects or criteria used to retrieve the set of results.

17. One or more non-transitory computer-readable media storing instructions that are operable, when executed by one or more computers, to cause the one or more computers to perform operations comprising:
receiving, by the one or more computers, a prompt from a user;
obtaining, by the one or more computers, code or instructions generated by one or more artificial intelligence or machine learning (AI/ML) models, wherein the code or instructions specify criteria to retrieve data from a data source to respond to the prompt;
generating, by the one or more computers, a set of results from the data source based on the generated code or instructions;
obtaining, by the one or more computers, a response to the prompt that the one or more AI/ML models generate using at least a portion of the set of results;
generating, by the one or more computers, an interpretation statement that indicates how the prompt was interpreted by the one or more AI/ML models; and
providing, by the one or more computers, output that includes (i) the response to the prompt and (ii) the generated interpretation statement.

18. The one or more non-transitory computer-readable media of claim 17, wherein the one or more AI/ML models comprise a large language model (LLM).

19. The one or more non-transitory computer-readable media of claim 17, wherein the interpretation statement comprises a summary or description of information that the code or instructions are configured to obtain from the data source.

20. The one or more non-transitory computer-readable media of claim 17, wherein the interpretation statement indicates data objects or criteria used to retrieve the set of results.
